(19) United States
(12) Patent Application Publication
(10) Pub. No.: US 2009/0204526 A1
(43) Pub. Date: Aug. 13, 2009

(54) METHOD AND SYSTEM FOR UTILIZING A FLEXIBLE CASE MODEL FOR COLLECTIONS

(75) Inventors: Randall S. WELLONS, Washington, DC (US); Kent Hayato TAKATA, San Francisco, CA (US); Gregory Wheatley, Fredericksburg, VA (US)

Correspondence Address: POSZ LAW GROUP, PLC, 12040 SOUTH LAKES DRIVE, SUITE 101, RESTON, VA, 20191, US

(73) Assignee: CGI Technologies and Solutions Inc., Fairfax, VA (US)

(21) Appl. No.: 12/030,690

(22) Filed: Feb. 13, 2008

(51) Int. Cl. G06Q 40/00

(52) U.S. Cl. 705/35

(57) ABSTRACT

A computer-implemented method and system for creating a flexible case model for use in managing collections of multiple accounts of a customer needing collection. Attributes are defined, each of the attributes including a data source, wherein the data source can be inherited or rolled up. Plural different entity models are defined, wherein each of the entity models includes a plurality of the attributes, the different entity models being (i) a finance entity, and (ii) a promise entity which a customer can promise to pay. Plural collection object models are defined, wherein each of the collection object models includes a plurality of the entity models, including a finance entity and a promise entity. Where the plural collection object models sit in a case model hierarchy is defined, wherein a case represents multiple accounts of a customer needing collection.

### CROSS-REFERENCE TO RELATED APPLICATIONS

This application is a continuation-in-part of U.S. patent application Ser. No. ______, filed Jan. 7, 2008, titled “METHOD AND SYSTEM FOR MANAGING CASE BASED PROMISES TO PAY”, hereby incorporated in its entirety.

### TECHNICAL FIELD

The technical field relates to a computer assisted credit management system including a collection system and, more particularly to a flexible case model which define the structure and relationship of the collection data.

### BACKGROUND

### Description of the Related Art

Computer assisted credit management systems, including computer assisted collection systems, are known in the art. Generally, a collection system, such as a full collections system, may include a variety of components, such as a Collection Engine, a Decision Engine, a User Interface (for either a collector or customer), and other components. A collector is a user of a collection system whose primary job is to use a collection system to facilitate collecting payments on accounts needing collection action, such as delinquent accounts, overlimit accounts, special status accounts, etc. Collection systems generally include parameters, such as collection policy parameters. Collection policy parameters are used by credit granting institutions to specify how a collection system implements the collection policy of the credit granting institution.

Examples of computer assisted collection systems include the Computer Assisted Collection System™ (or CACS®), by American Management Systems, Inc. (AMS), and its several versions including CACS® Enterprise, Computer Assisted Collection System™ for Government (including TRACE™), and CACS®-Telecom.

CACS® Enterprise is explained in the CACS® Enterprise Product Profile, March 1998 by AMS, incorporated herein by reference. Prior versions of computer assisted collections systems such as CACS® Enterprise have been in use for many years, with the CACS® Baseline having been in use since approximately 1984, with approximately 200 collections organizations worldwide using various interfaces, such as a CACS® Enterprise 3270 interface, an AS/400™ interface, and PowerBuilder™ (for CACS®-T and CACS®-G).

CACS® Enterprise, such as CACS® Enterprise 7.0, is a member of the AMS series of credit management software that supports all phases of credit operations, from initial application processing through servicing and accounting to collections. Available exclusively through AMS, each system can be installed individually, collectively, or in any combination to address evolving support requirements.

The Computer Assisted Collection System™ for Government is explained in the CACS Plus® Product Profile (Client/Server version) by AMS, August 1997, and incorporated herein by reference. CACS® Telecom is explained in the CAC®-Telecom Product Profile by AMS, September 1998, incorporated herein by reference. In addition, there are mainframe versions of CACS®, having a 3270 interface thereto, such as TRACE.

Computerized tracking of promises to pay is also known in the art. CACS® Enterprise records promises to pay. More particularly, CACS® Enterprise supports recording of promises on collection accounts.

In the computer assisted collection systems of the related art, such as CACS® Enterprise, the user (for example, the collector), provides the system with arrangements of repayment of an outstanding debt referred to as promises to pay, by the account holder. CACS® Enterprise relies on customer account data and collection parameters entered into the collection system by the system administrator to validate reactively the collector-entered promise terms, including promise amounts, dates, and schedules.

Generally, in the computer assisted collection system of the related art, the arrangements of the promises to pay (such as payment amount and frequency of payment) are negotiated between the collector and the account holder, and are then input into the computer assisted collection system of the related art for verification against criteria previously established and provided therein. If the negotiated arrangements of the promises to pay are not within the criteria provided in the computer assisted collection system, an error message is displayed to the collector indicating that the arrangements are not accepted by the computer assisted collection system. The collector must then re-negotiate the arrangements with the account holder, and enter the re-negotiated arrangements into the computer assisted collection system for verification.

The process of negotiation and verification continues until the arrangements of the promises to pay are acceptable to the collector, the account holder, and the computer assisted collection system.

FIG. 1 shows an example of a collection cycle 12 for a payment promise using CACSe Enterprise, as an example using a collection system 20 of the related art. The collection system 20 of the related art may be provided in a mainframe or a client/server environment.

As shown in FIG. 1, in operation S10, an accounting system downloads collection accounts to the collection system 20 of the related art for collection activities. Then, in operation S12, the collector requests of the collection system 20 an account. Based upon the account returned from the collection system, in operation S14, the collector then negotiates with the customer (or account holder) the arrangements of the promise to pay. Next, in operation S16, the collector records in the collection system 20 the payment arrangements (or agreement) reached with the customer. The collection system 20 then verifies whether the payment arrangements meet the criteria provided in the collection system 20, as shown in operation S18. If there are errors in the payment arrangements (i.e., the payment arrangements do not satisfy the collection parameters stored in the collection system), then the part of the collection cycle of the prior art beginning with operation S14 is repeated until there are no errors in the payment arrangements.

In the meantime, control is returned to operation S12 and the next account is obtained by the collector from the collection system.

FIG. 2 shows a screen layout 30 from a current CACS® Enterprise 3270 mainframe display, for a particular account. As shown in FIG. 2, the screen layout 30 includes account holder demographics 32, account summary data 34, account data view and scripts (including information such as the date the account was opened, the credit limit, the date of the last bill, the balance, the amount in dispute, the total amount due currently, the amount that is over the credit limit, the amount that is late, and the aged data) 36, and an account history 38 (including previously-made promises) which includes an area for the collector to interact with the collections system.

Promises in CACS® Enterprise are now discussed. Collectors can make arrangements with account holders for one or two payments (standard promises), or for a series of weekly, bi-weekly, or monthly payments (long-term promises or deferred payment arrangements). Standard and long-term promises, as well as deferred payment arrangements, are described in further detail in the following paragraphs.

Standard Promises

The CACS® Enterprise mainframe screen display includes a Coded Collection History line having fields such as PROMISE 1 and PROMISE 2. Collectors may enter a single promise by filling an amount and date in the PROMISE 1 fields of the Coded Collection History line. Collectors may enter two promises by filling in both the PROMISE 1 and PROMISE 2 fields. CACS® Enterprise validates the promise amount and date entered according to parameters entered in management control tables.

Long-Term Promises

CACS® Enterprise considers any payment arrangement extending for more than two payments as a long-term promise. To enter long-term promises, collectors enter the amount and date of the first payment, along with the amount of the long-term promise amount for the weekly, biweekly or monthly payment.

Deferred Payment Arrangement

A Deferred Payment Arrangement (DPA) is another type of promise CACS® Enterprise supports. Collectors set up a DPA to record a weekly, biweekly, or monthly promise for the current bill plus an agreed—upon monthly payment which is applied to the outstanding delinquency.

In a typical collection system of the related art, delinquent accounts are arranged into groups, then into queues within the groups, in accordance with rule-based criteria. Each collector is provided by the collection system with a next account from a particular queue. For example, CACS® Enterprise divides accounts into groups based upon parameters such as front end parameters, midrange parameters, and other group parameters, which are discussed herein below.

Queues of accounts are also built by CACS®. The queues include accounts requiring the same next action, e.g., send a letter, contact customer for a payment promise. Rules are defined to control the movement of accounts between queues. Queues are defined for special purposes, such as supervisor review. If a collector cannot come to acceptable terms within parameters on a payment promise, the account is routed to a supervisor queue for out-of-tolerance promise approval/denial. Approved payment promises are put into the proper queue to wait for promise fulfillment; denied payment promises are returned to the collector for re-work.

Known in the art are systems which offer recommendations of promises for a particular account using a single account's data. More particularly, known in the art is a promise advising system in which a decisioning component evaluates and recommends suggested payments based on decision trees. Decision trees, or decision engines, are also known in the art.

A concept previously proposed, although not embodied, includes a promise advising process which evaluates and presents recommended payment amounts using account and/or customer data.

A problem with credit management systems, and more particularly collection systems, is the use of account-based processing where each account stands on its own and is evaluated and processed separately.

### SUMMARY

Accordingly, one or more embodiments provide a system, device, and/or computer-implemented method of creating a flexible case model for use in managing collections of multiple accounts of a customer needing collection. The method can include defining attributes, each of the attributes including a data source, wherein the data source can be inherited or rolled up. The method also can include defining plural different entity models, wherein each of the entity models includes a plurality of the attributes, the different entity models being (i) a finance entity, and (ii) a promise entity which a customer can promise to pay. Also, the method can include defining plural collection object models, wherein each of the collection object models includes a plurality of the entity models, including a finance entity and a promise entity; and defining where the plural collection object models sit in a case model hierarchy, wherein a case represents multiple accounts of a customer needing collection.

Other embodiments provide a system, device, and/or computer-implemented method of using a flexible case model in managing collections. A case model hierarchy is used to display a case, wherein an attribute can be displayed as inherited or rolled up and contact entities for the case object and its child case objects are displayed as a view, grouped together at a parent level view, wherein a case includes information for respective multiple accounts of a customer needing collection.

Still other embodiments can provide a computer-implemented data management system for using a flexible case model for managing collections of multiple accounts of a customer needing collection. The system can include a case model creator and a display component. The case model creator can be configured to define and create attributes, each of the attributes including a data source and attribute description, wherein the data source can be inherited or rolled up; define and create plural different entity models, wherein each of the entity models includes a plurality of attributes, the different entity models being (i) a finance entity, and (ii) a promise entity which a customer can promise to pay; and define and create plural collection object models, wherein each of the collection object models includes a plurality of entity models, including a finance entity and a promise entity; define where the plural collection object models sit in a case model hierarchy. The display component can selectively display the collection object for a case to a user in order and with roll-ups and inheritance of the case model hierarchy. A case can represent multiple accounts of a customer needing collection.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

These and other objects and advantages of the invention will become apparent and more readily appreciated from the following description of the preferred embodiments, taken in conjunction with the accompanying drawings of which:

FIG. 1 is a flowchart showing the collection cycle establishing a payment promise using collection systems of the related art;

FIG. 2 is a diagram of a collection system display screen for a 3270 mainframe display of the related art;

FIG. 3 is a hardware architecture diagram of a network 74 including client personal computers 75 executing promise option advisory module software 62;

FIG. 4 is a data flow diagram showing data flow in a preferred architecture of a computer system 76 implementing the promise option advisory module 62;

FIGS. 5A-5D are illustrations of portions of an exemplary user interface;

FIGS. 6A-6E are illustrations of portions of another exemplary user interface;

FIG. 7 is an illustration of a flowchart of a collection cycle including case based promises to pay;

FIG. 8 is a block diagram illustration portions of an exemplary computer system for managing case based promises to pay;

FIG. 9 is a flowchart illustrating an exemplary procedure for managing case based promises to pay;

FIG. 10 is a flowchart illustrating a data flow;

FIG. 11 is an illustration of a case model hierarchy;

FIG. 12 is an illustration of a flexible entity data model;

FIG. 13 is an illustration of a user interface for a case model hierarchy creation;

FIG. 14A to FIG. 14C are illustrations of user interfaces for a case level collection object model;

FIG. 15 is an illustration of a top of a user interface for an attribute detail;

FIG. 16A to FIG. 16B are illustrations of a middle and bottom of the user interface for an attribute detail;

FIG. 17A is an illustration of a user interface for an attribute formula, FIG. 17B being an alternate user interface;

FIG. 18 is an illustration of a user interface for a collection object model page;

FIG. 19 is an illustration of a user interface case model hierarchy for a collection object model of FIG. 18;

FIG. 20 illustrates portions of an exemplary computer system for flexible case models; and

FIG. 21 is a flow chart illustrating an exemplary procedure for flexible case models.

### DETAILED DESCRIPTION

Reference will now be made in detail to the embodiments, examples of which are illustrated in the accompanying drawings, wherein like reference numerals refer to the like elements throughout. The embodiments are described below by referring to the figures.

As further discussed herein below, various inventive principles and combinations thereof are advantageously employed to provide a more holistic “customer centric model” in which all of a customer's accounts can be viewed. In collections, companies are contacting customers that are not paying bills as agreed to get them to pay up. There is a big difference in treating an individual account without the knowledge of other accounts that a customer may have with that company, and looking at all accounts that a customer may have in collections or not in collections with that company, to put them through a defined set of sets (for example, collections, letters, customer calls, and the like). Collections treatment and processing at the case level covering potentially all of the customer's accounts will allow the company, such as a credit grantor, to determine appropriate next actions and collections treatment using the context of the customer and their accounts, as contrasted with collections treatment at the account level that only determines a next action based on a single account's data. Accordingly, treatment at the customer level can be much more useful because a broader context of the entire customer relationship with the credit grantor can be utilized.

Further in accordance with exemplary embodiments, a flexible case model can be used to set up the structure of a case, to support levels in a model hierarchy, to determine logical groupings of types of accounts so that the data will make sense to the person, usually the collector, viewing the data through the user interface, and also so that the data will have a known structure so that the systematic processing of the data can be carried out through rules, engines, data handlers, and the like. Embodiments support the ability to create, use, and manage case models which can be different from client to client depending on the client's business, how they operate, and their desired roll-ups of data for presentation to the collection and to internal processes.

Tables 1 and 2 below provide examples of how different clients might want to set up different case models, which are merely illustrative of numerous different ways different clients might want their case models. Table 1 concerns a bank as a client, whereas Table 2 concerns a telecommunications/media client. In Table 1, for the client, such as a bank, there is a customer with individual accounts, for example, a credit card, home loan, and car loan.

TABLE 1
Bank Customer

| | |
|---|---|
| Customer (CASE) | Highest Level 1 |
| Credit Cards | Roll Up Level 2 |
| MasterCard Account | Roll Up Level 3 |
| MC Account #5428123412341234 | Account Level |
| Visa Accounts | Roll Up Level 3 |
| Visa Account #4271123412341234 | Account Level |
| Loan Accounts | Roll Up Level 2 |
| Car Loans | Roll Up Level 3 |
| CL #1234567890 | Account Level |
| Installment Loans (Unsecured) | Roll Up Level 3 |
| IL #9876543210 | Account Level |
| IL #1112223334 | Account Level |
| Mortgages | Roll Up Level 3 |
| M #888777666555 | Account Level |

Juxtapose Table 1 with how a telecommunications/media client might want to set up a case for its customers, as shown in Table 2:

TABLE 2
Telecommunications/media client:

| | |
|---|---|
| Customer (CASE) | Highest Level 1 |
| Wired | Roll Up Level 2 |
| Local Service Accounts | Roll Up Level 3 |
| Line Account #2025557878 | Account Level |
| Feature Packages | Roll Up Level 3 |
| Pkg Account #2022557878 P01 | Account Level |
| Pkg Account #2022557878 P02 | Account Level |
| Long Distance Packages | Roll Up Level 3 |
| Pkg Account #2022557878 L01 | Account Level |
| Wireless | Roll Up Level 2 |
| Wireless Phone Accounts | Roll Up Level 3 |
| Line Account #2025550101 | Account Level |
| Feature Packages | Roll Up Level 3 |
| Pkg Account #2022550101 P01 | Account Level |
| Data Packages | Roll Up Level 3 |
| Pkg Account #2022550101 D01 | Account Level |
| Pkg Account #2022550101 D02 | Account Level |
| Wireless Broadband Accounts | Roll Up Level 3 |
| Line Account #2025557777 | Account Level |
| Media Accounts | Roll Up Level 2 |
| Cable | Roll Up Level 3 |
| CA #1234567890 | Account Level |
| DSL | Roll Up Level 3 |
| DSL #9876543210 | Account Level |
| DSL #1112223334 | Account Level |
| Wireless Broadband Accounts | Roll Up Level 3 |
| WB #2024447777 | Account Level |

The definition of levels can enable the user to view roll-ups in a financial summary of the totals for the items below (for example, the two Data Package accounts would roll up into a total aggregation for the two accounts, as well as letting the user see the details at the account level. Accordingly, a client can set up a flexible entity model for its organization depending on how that client wants to see the account data and roll ups.

An exemplary use of flexible case models in collections is in a promise management system. A payment promise is a commitment made by an account holder to a collector for payment by the account holder of money owed. The payment promise can include many options, but typically includes an amount of money owed and frequency of payments as two of those options. To speed up negotiating and recording of mutually-agreeable payment promises, a computer-based promise management system proactively calculates, by a promise option advisory software module of the promise management system, available promise options using customer account data and collection parameters entered into the collection system by the system administrator.

The promise management system, through the promise option advisory module included therein, uses account data, drawn from multiple accounts of the customer, and/or customer data (which is data about the customer relationship (also referred to as relationship-specific information)), to recommend promise options for that customer, as discussed herein below.

Accordingly, account data about a customer is not confined to a single account of the customer, but includes data from the multiple accounts of the customer and the relationship-specific information. Thus, the promise option advisory module interfaces to a decision engine (which calculates the recommended best and minimum promise and validates a user-entered promise) and, optionally, to a collection system, to transmit and receive various data, as described herein below.

By proactively recommending valid payment promise terms and a recommended best or minimum payment option, and allowing the collector to record the suggested promise, for example by selecting the suggested promise using a push-button, the promise management system reduces the incidence of errors and the overall time required to solicit and record a payment promise that is within credit policy guidelines.

The promise management system operates in conjunction with a collection system of the related art and includes a graphical user interface (GUI) which displays a promise management screen, in the form of a promise management action dialog, to the user when the user selects a Promise tab displayed on a collection display screen.

The promise management portion of the action dialog includes several group boxes, described in detail herein below, including a promise option advisory group box which presents to the user predetermined promise options including minimum promise amount, maximum promise date, delinquent amount, current amount due, balance on account, overlimit amount, recommended best promise amount, and recommended best promise date. As described herein below, the minimum promise amount and the maximum promise date are calculated by a promise option advisory module based upon other promise options which are stored in and retrieved from the collection system (or from a separate database accessible by both the collection system and the promise option advisory module).

The recommended best promise amount is the amount that the customer should ideally pay based on decision logic, including account data drawn from multiple accounts of the customer, customer data, credit granting institution policy, etc. Likewise, the recommended best promise date is the date on which the customer should ideally pay based on the above-mentioned decision logic.

The users may include a collector, the account holder, or other types of users as will be apparent from the description below. For the purposes of the following discussion, the user will be referred to as the collector, In addition, the prior art collection system referred to is the CACS® Enterprise system. However, other collection systems may be used in place of, or in conjunction with, the CACS® Enterprise system.

The promise management system downloads customer data, account data, and collection parameters retrieved from the collection system, to the collector's computer when retrieving an account for collections work.

Other data related to the case can include, for example, the place of contact of the account holder, the party contacted, the disputed amount, the route to state indicating which queue to route the resulting account to for promise approval or receipt of payment, the hold date, the excuse, and the time for scheduling another call. Each of the foregoing fields is populated by the user based upon information received from the account holder.

Other examples of data in a collection system can include minimum promise amount, maximum promise date, delinquent amount, current amount due, balance on account, overlimit amount, Recommended Promise 1 amount, and Recommended Promise 1 date. The promise option advisory fields can be populated by the promise management system upon display of the promise management action dialog to the user, in accordance with the flexible case model, in addition to a collection policy or guidelines entered into the collection system (such as CACS® Enterprise) to which the promise management system interfaces.

Account data is now explained in further detail. The promise option advisory module uses all available account data, including both customer-level data (such as the above-mentioned relationship-specific information) for the customer and data drawn from multiple accounts of the customer, to recommend a promise option that is in the best interest of the financial institution and the customer and which follows the credit granting institution's current policy as implemented in the promise management system. Accordingly, the promise option advisory module makes promise recommendations based on all known, available information about the customer.

To determine the promise options for a customer presented to a user, the promise option advisory module analyzes the data from the multiple, individual accounts of the customer, then analyzes the relationship-specific information for the customer, to determine an optimal promise payment strategy, which is reflected in the recommended best payment option of the promise options presented to the user for a particular customer.

For each customer, analysis by the promise management system, when coupled to a decision engine, includes all or a portion of the following functions, the calculations and determinations for which are performed by the decision engine:

a.) devising strategies to bring all of the multiple, individual accounts up to date over a period of time;

b.) determining which of the multiple, individual accounts should be brought up to date first based on balance or risk of an individual account as compared to other individual accounts;

c.) implementing the credit granting institutions collection strategy (e.g., reduce mortgage delinquency first); and

d.) comparing profitability of each of the multiple, individual accounts.

The promise option advisory module then performs additional analysis of the account data for a customer based upon customer level data (or relationship-specific data), to recommend the optimal promise payment strategy. The additional analysis based on customer level data includes past and future customer value/profitability, risk of additional delinquency, likelihood of attrition, likelihood of a customer accepting a particular promise scenario, and follow through on previous accepted payment plans.

All of the above-mentioned components of the account data can be weighted and analyzed in accordance with criteria established within the promise management system, in accordance with credit policy guidelines of the institution managing the promise management system

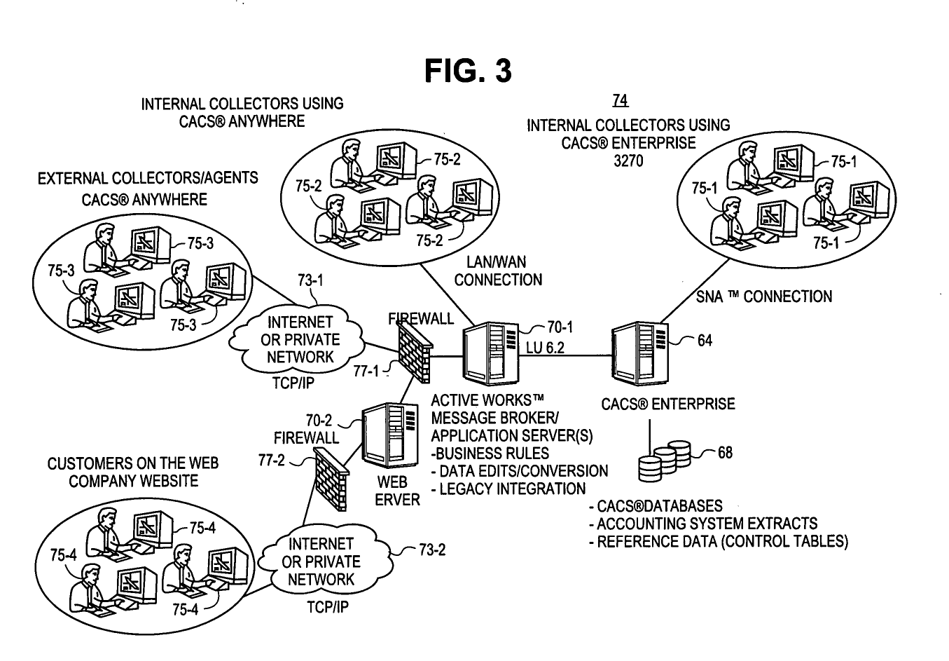

FIG. 3 is a hardware architecture diagram of a network 74 including client personal computers 75 executing promise option advisory module software 62. The configuration of the network 74 shown in FIG. 3 is customizable from client to client, and the particular configuration shown in FIG. 3 is not required for successful operation of the promise option advisory module.

As shown in FIG. 3, a collection system 66 is executed by a mainframe computer 64, including a database 68 storing data extracted from an account and reference data such as control tables. The mainframe computer 64 is coupled to a middleware server 70-1, including a message broker/application server. The message broker/application server 70-1 passes the data, but may store business rules, data edits and conversions, and legacy integration information. The message broker/application server is coupled to a Firewall 77-1, to PCs 75 through a local area network (LAN) or wide area network (WAN) connection, and to PCs 75 through System Network Architecture™ (SNA™) connections.

The users of the PCs 75-1 coupled to the computer 64 through the SNA™ connection are internal collectors using CACS® Enterprise 3270. The users of the PCs 75-2 coupled to the middleware server 70-1 through the LAN/WAN connection are internal collectors using application software in which the promise option advisory module 62 is included, referred to as CACS® Anywhere.

Through a Firewall 77-1, the middleware server 70-1 is coupled over a TCP/IP connection through the internet or a private network 73-1 to PCs 75-3 used by External Collectors/Agents using application software in which the promise option advisory module 62 is included (CACS® Anywhere).

Also through Firewall 77-1, the middleware server 70-1 is coupled to web server 70-2. Then, over TCP/IP connection through Firewall 77-2 and the Internet or a private network 73-2, the web server 70-2 is coupled to PCs 75-4 used by customers accessing a companys 3 website on the worldwide Web.

The mainframe computers 64, the middleware servers 70, and the network 73 are known in the art.

The decision engine is now briefly explained. Decision engines, generally, are well-known in the art. The decision engine implements a rules based decision management system, which is a computer implemented system applying strategies to determine actions to be taken, monitoring performance based on the taken actions, and providing a manner to refine the strategies in accordance with the monitored performance. An example of a decision engine is discussed in U.S. Pat. No. 6,601,034, DECISION MANAGEMENT SYSTEM WHICH IS CROSS-FUNCTION, CROSS-INDUSTRY AND CROSS-PLATFORM, which is expressly incorporated herein by reference. For example, the AMS Strata® decision support system is a software based system which applies predictive modeling techniques to customer data, to thereby generate dramatic improvements in the effectiveness and profitability of customer interactions, as discussed in U.S. Pat. No. 6,321,206, DECISION MANAGEMENT SYSTEM FOR CREATING STRATEGIES TO CONTROL MOVEMENT OF CLIENTS ACROSS CATEGORIES, which is expressly incorporated herein by reference. The AMS Strata® decision support system release 2.0 was released in 1993, and subsequent releases are currently available.

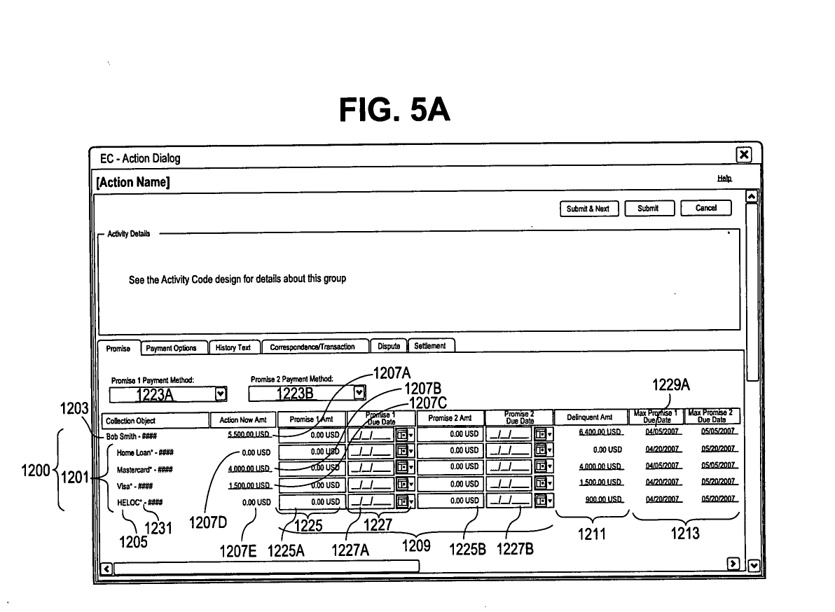

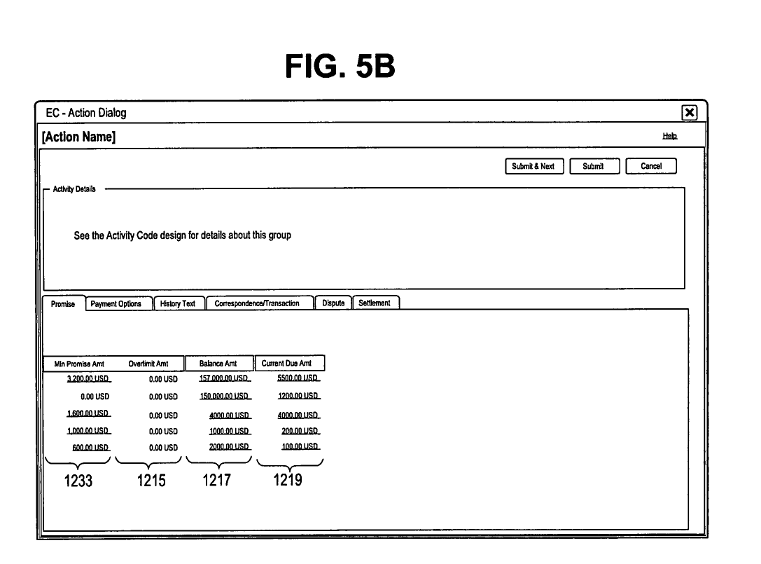

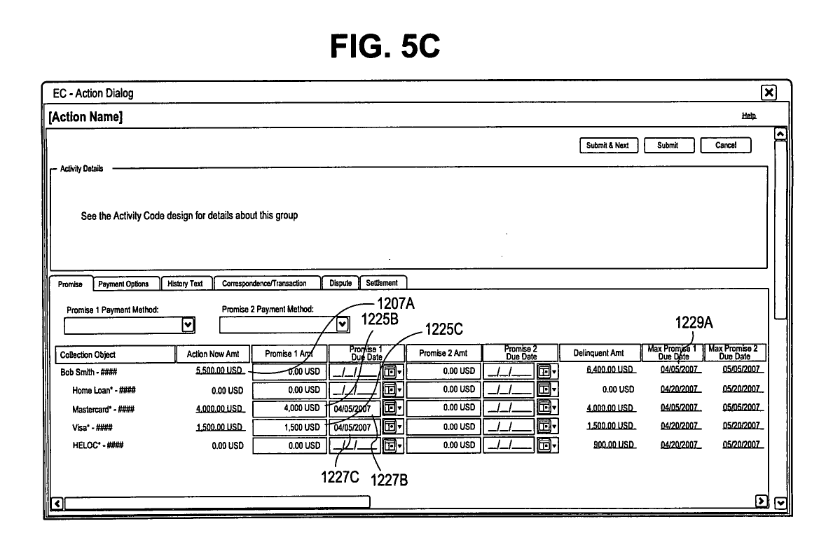

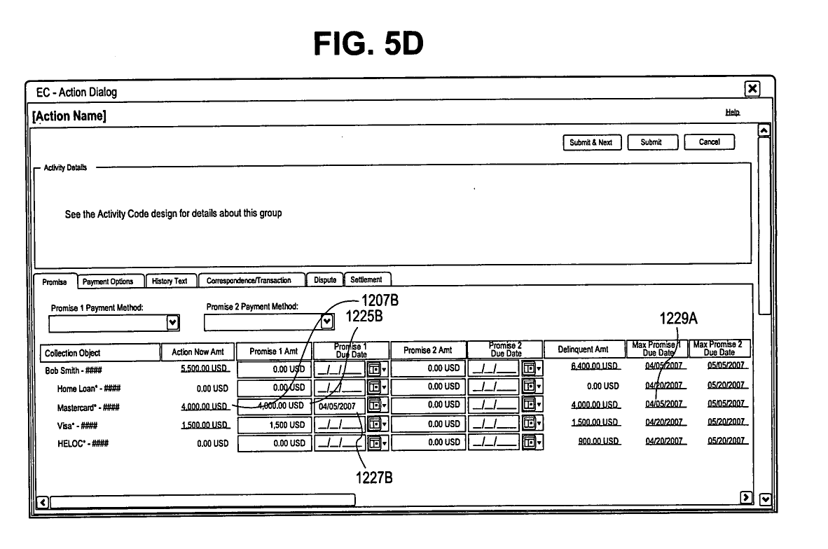

A case based promises embodiment is discussed in connection with FIGS. 5A-5D, FIGS. 6A-6E, and FIGS. 7-10. A case based promises embodiment results in a shift from a collections business model using account based processing where each “account” stands on its own and is evaluated and processed separately, to a system where all of the customer's accounts are dealt with as a “case”. The accounts in a case are organized as a “customer hierarchy” which illustrates a hierarchy relationship between the accounts for the case, as discussed in more detail below. Processing at the case level (that is, a top level in the customer hierarchy) allows the credit grantor to determine actions and collections treatment in the context of the customer and their multiple accounts. Customer, in this context, refers to an individual, an entity (such as a business), or a combination of one or more individuals and/or entities. For example, a customer might be a household which is a group of individuals living at the same address, or a business which is specified individuals plus the ultimately responsible business (useful for cellular telephone or business charge accounts), or a partnership, and the like, or variations thereof.

The embodiment can include calculating, displaying and taking a commitment to pay an amount that is owed an organization based upon the organizational relationship defined as a case. The organizational relationship defined as a case consists of accounts that are logically grouped together to form a single case. The case based promise embodiment can calculate the amount for a case based promise and can disperse the case based promise across the accounts allowing a system user to initiate a promise using a single click of the mouse. A user interface displays a summary of the customers and/or accounts that make up the case and provides the implementation for a system user to take the case based promise.

A case based promises embodiment can provide a summary of an action now amount, where the “action now amount” is defined as the optimal amount(s) that the collector needs to get a commitment to pay from the customer. The action now amount can be, for example, a recommended promise amount from the decision engine (discussed above). The data displayed to the collector is the result of configurable rules using the account data, with roll-ups to the higher levels of amounts in the customer hierarchy. The collector can select, e.g., a hyperlinked amount to cause the recording of the promise at multiple levels in the customer hierarchy.

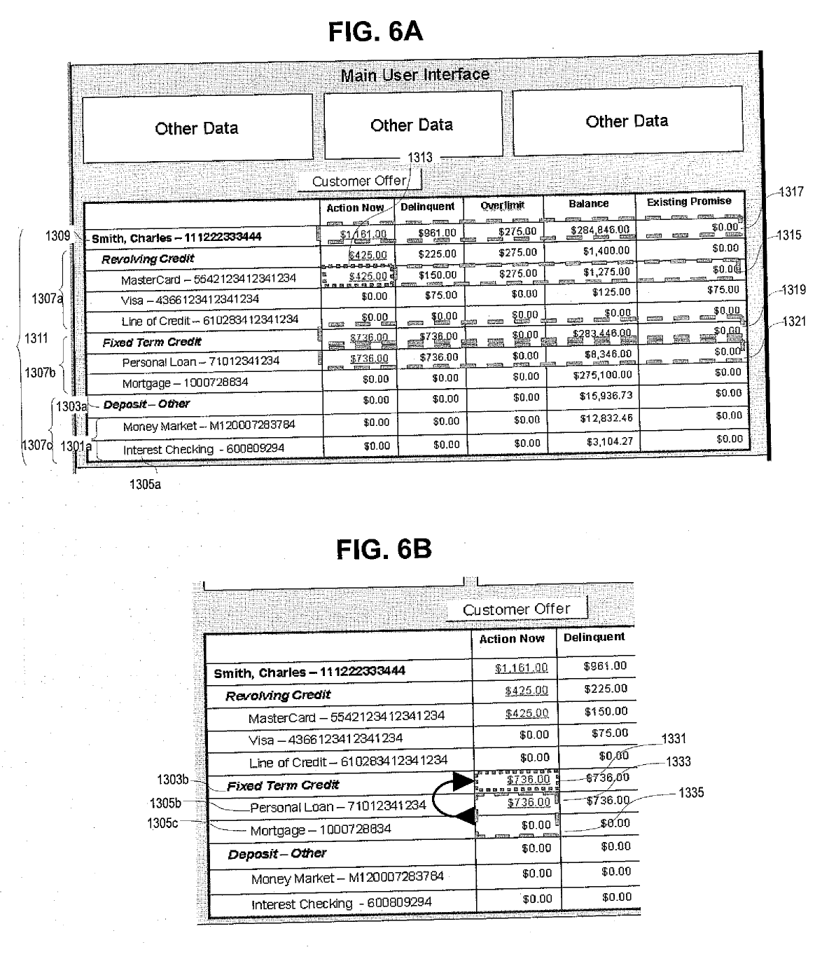

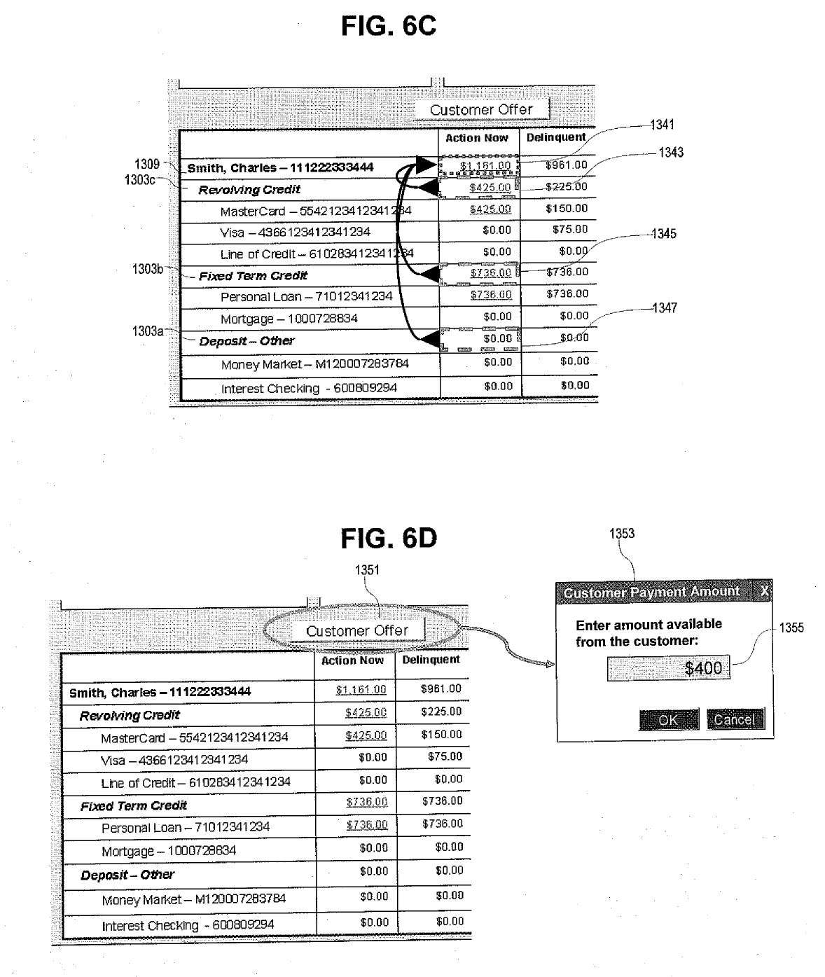

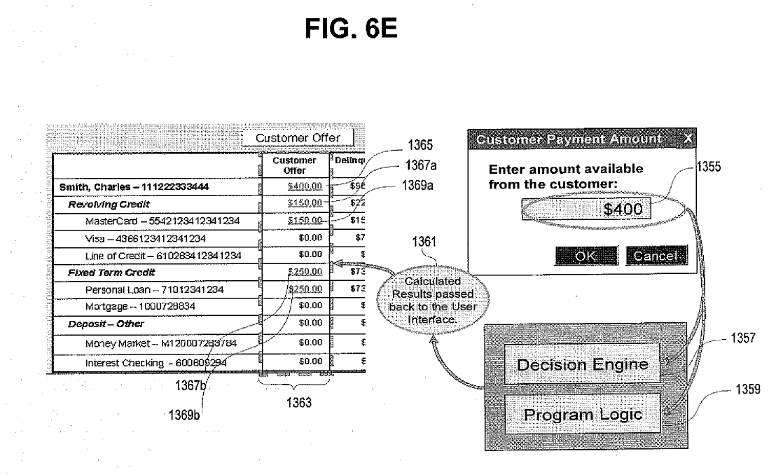

FIGS. 5A-5D relate to a representative hypothetical customer, Bob Smith, and FIGS. 6A-6E relate to a different representative hypothetical customer, Charles Smith. The account level information used for each respective customer is consistent, with a case for customer Charles Smith having a more complex customer hierarchy than a case for customer Bob Smith.

Referring now to FIGS. 5A-5D, illustrations of portions of an exemplary user interface will be discussed and described. In overview, FIG. 5A illustrates an initial page for case based promises, FIG. 5B is a continuation of the initial page illustrated in FIG. 5A, FIG. 5C is a different page in which a collector chooses to collect an entire action now amount, and FIG. 5D is another page in which the collector chooses to collect an action now amount for a lower level in the customer hierarchy. Each figure is further explained below.

FIG. 5A and FIG. 5B together illustrate an initial page for case based promises, with the user scrolling right from FIG. 5A to FIG. 5B. FIGS. 5A-B illustrate an account level 1201 including plural accounts 1205, a customer level 1203. A customer hierarchy 1200 includes one or more accounts 1205 in one or more account levels 1201 and a customer 1203. A customer hierarchy 1200 providing a display of a case can further include group levels and sub group levels (not shown) in between the customer and account levels.

Also illustrated is a promise advisor portion 1209 showing promise amounts (e.g., 1225a, 1225b), minimum promise amounts 1233, promise due dates (e.g., 1227a, 1227b), maximum promise due dates 1213 for each account level 1201.

The action now amounts 1207a-e are optimal amounts for a customer to pay. The action now amounts can be determined using rules. In this example, the rule for determining the action now amounts for account levels calculates based on the delinquent amount for the account level. Other rules, however, can be used to determine an optimal action now amount. Such rules can consider account financial attributes, system attributes, and various scoring methods, as discussed above. For example, the action now amounts can be defined as the “recommended promise amount” discussed above, and can be calculated in the same fashion as the recommended promise amounts.

Also illustrated are action now amounts 1207a-1207e for each level (e.g., customer level 1203, account levels 1205, and any intervening levels (discussed and illustrated below)). For example, if the promise amount=0, then the action now amount can be set to the delinquent amount plus the overlimit amount. The illustrated user interface can display conventional information for any or all levels of the customer hierarchy, for example a delinquent amount 1211, an over-limit amount 1215, a balance amount 1217, and a current due amount 1219.

The action now amounts 1207b, 1207c, 1207d, 1207e for account levels in the customer hierarchy 1200 are added to obtain the action now amount 1207a for the next higher level in the customer hierarchy 1200, in a recursive manner up to the customer level 1203. The closest maximum promise due date 1213 for account levels is used to obtain the maximum promise due date 1229a for the next higher level in the customer hierarchy 1200, in a recursive manner up to the customer level 1203. In the illustrated example, the maximum promise due dates for the account levels just below the case levels for promise 1 are Apr. 20, 2007 and Apr. 5, 2007, and for promise 2 are May 20, 2007 and May 5, 2007. Assuming that the current day is earlier than any of those days, the closest maximum promise due date is Apr. 5, 2007 because that date is the next to occur of the maximum promise due dates for account levels below the next higher level (in this example, the case level). As illustrated, the Apr. 5, 2007 date is used as the maximum promise due date for promise 1 1229a for the next higher level, that is, the case level. This maximum promise date 1229a would also be used in connection with the action now amounts that are selected.

One or more of the promise amount fields 1225 and/or the promise due date 1227 fields can be manually entered by a user, if desired. Optionally, one or more of the promise amount 1225 fields can be filled in using the links from the columns for action now amount 1207a-e, delinquent amount 1211, minimum promise amount 1213, overlimit amount 1215, balance amount 1217, and/or current due amount 1219. Optionally, one or more of the promise due date 1227 fields can be filled in using the links for the respective columns maximum promise 1 due date or maximum promise 2 due date 1213.

The payment methods 1223a, 1223b can define a means of providing payment for a specific promise, such as a check payment at a branch, a check payment via mail, a credit card payment by telephone, and the like.

FIG. 5C is a page in which a collector chooses to collect an entire action now amount, to be dispersed to lower levels in the customer hierarchy. For example, the collector can click on the customer action now amount 1207a and a maximum promise 1 due date 1229a for the customer level. The system then disperses the action now amount to lower levels by pre-filling the promise amount fields with partitioned amounts of the action now amount for all levels below the level of the selected action now amount.

In this illustration, the selected action now amount is at the customer level 1207a. The promise amount fields 1225b, 1225c and promise due date 1227b, 1227c fields for the lower levels are then filled in, where the account level action now amount is non-zero.

Here, the selected action now amount for the customer is $5,500, with a maximum promise due date of Apr. 5, 2007. The promise amounts of $4,000 and $1,500, corresponding to the partitioned amounts of the action now amounts for the account levels, are pre-filled into the promise amount fields 1225b, 1225c and the maximum promise due date of Apr. 5, 2007 is pre-filled into the promise due date fields 1227b, 1227c.

More particularly, the action now amount which is selected is dispersed down to its lower levels in the customer hierarchy, according to the action now amounts which were previously determined at the lower levels. The dispersing downward of the action now amount is recursive, through intervening levels (if any, as shown in FIGS. 6A-6E) to the lowest levels. Separately, the closest maximum promise due date 1229a can be copied to the promise due date fields 1227b, 1227c for account levels which have action now amounts. Note that a collector can manually set a promise due date, for example, by clicking on the promise due date 1227b, 1227c and entering the desired date.

FIG. 5D is another page for a scenario in which the collector chooses to collect an action now amount for an account level in the customer hierarchy. Here, the collector clicks on the “Mastercard” action now amount 1207b of $4,000, and clicks on the maximum promise due date 1229a of the account level for the Mastercard. For the account level, the system pre-fills the promise amount 1225b and the promise due date 1227b, only for the account level, from the action now amount 1207b and the maximum promise due date 1229a, respectively. The collector can manually edit the other fields, if desired, by entering a promise amount 1225b and promise due date 1227b.

Referring now to FIGS. 6A-6E, illustrations of portions of another exemplary user interface will be discussed and described. In overview, FIG. 6A illustrates a page with a more complex customer hierarchy for hypothetical customer Charles Smith, FIG. 6B illustrates a page with action now amounts for an account level rolling up to a group level, FIG. 6C illustrates a page rolling-up group levels up to a customer level, FIG. 6D illustrates a customer offer interface, and FIG. 6E illustrates a flow distributing the customer offer among lower levels in the customer hierarchy. Each figure is further explained below.

FIG. 6A illustrates a page with a more complex customer hierarchy for hypothetical customer Charles Smith. A customer hierarchy 1311 includes a customer 1309 and one or more intervening levels 1307a, 1307b, 1307c. Each of the intervening levels includes plural account levels 1301a (each with an account e.g., 1305a) and an intervening level object 1303a. The intervening level object 1303a describes the grouping of account by account types, e.g., “revolving credit,” “fixed term credit”, “deposit—other”. The information for the lowest levels, i.e., the account information, is rolled up to the intervening level (here, a group level), and ultimately to the customer level, sometimes referred to as the “case level.” This illustration shows single group levels, but there can be multiple levels of group levels intervening between the account level and the case level, such as group levels and sub-group levels.

Also illustrated is a case level financial roll-up 1317, an account type financial roll-up 1319, an account level financial data 1321. The account type or group level financial roll-up 1319 is a sum of the account level financial data 1321 in the levels hierarchically below it. The case level financial roll up 1317 is a sum of the account type financial roll-ups which are hierarchically below it.

In this example, action now amounts include an account level action now amount 1313 are presented for the collector to see and use in negotiations, and can be selected to record a promise for example via a hyperlink. Account level data 1315 can be evaluated with configurable rules applied to determine an optimal amount that the collector should negotiate with the customer for a promise to pay arrangement. Although this illustration uses a simple calculation, the configurable rule can include a more complex calculation.

In this example, the collector operating the user interface would only need to click the mouse on the “$1,161” hyperlinked field and it would record promises for all the accounts (lowest level) below it. Alternatively, if the customer only wanted to pay the Fixed Term Credit account, the collector can click the mouse on the $736 amount and it will record promises for all the account level objects below that which have an action now amount (Personal Loan).

This user interface offers a quick way to get to the crux of what the collector needs to get commitment from the customer in an easy to action format that is driven by parameters to determine the desired amount, and a facilitated way so that work can be done quickly.

Incidentally, the illustrated main user interface shows data in a condensed format for ease of the present discussion.

FIG. 6B illustrates a page with action now amounts for an account level rolling up to a group level. Here, there is one non-zero action now amount 1333 for account levels 1305b, 1305c, which are hierarchically below an intervening level 1303b. The account level action now amounts 1333 are totaled to provide an intervening level action now amount 1331.

FIG. 6C illustrates a page rolling-up group levels up to a customer level. The illustration shows three action now amounts 1343, 1345, 1347 for intervening levels 1303a, 1303b, 1303c, which are hierarchically below a case level 1309. The intervening level action now amounts 1343, 1345, 1347 are totaled to provide a case level action now amount 1341.

FIG. 6D illustrates a customer offer interface. In the event that a customer cannot pay the recommended “action now” amount, an alternative is to allow the customer to indicate the amount they can pay, and recommend how the customer offer amount should be applied to the accounts. A customer offer process can be launched, for example using a button 1351 to present a dialog for the collector to enter an amount that the customer tells them that they can pay. Here, a customer offer entry dialog 1353 is provided and includes a customer offer payment amount 1355 so the user can manually enter an amount which the customer offers.

Continuing on, FIG. 6E illustrates a flow distributing the customer offer among lower levels in the customer hierarchy. Here, the customer offer payment amount 1355 has been submitted. In this example, note that a customer offer column 1363 is now displayed. A background process such as a decision engine 1357 (described above), program logic 1359, or combination, evaluates the data to determine an optimal application of the funds. The decision engine 1357 also uses the customer data in the customer hierarchy as input to the decision engine 1357. Calculated results 1361 are passed back to the user interface and inserted as the customer offer column 1363. The customer offer amount 1355 is entered into a customer offer field 1365, and the calculated customer offer is distributed in the customer offer column 1363 among the levels which are hierarchically below the level in the customer hierarchy. Although this example shows a customer offer at the customer level, other embodiments can provide for a customer offer to be entered at a group level.

In this illustration, the partial customer offer is $400 for the case level 1365. The customer offer of $400 submitted to the decision engine 1357 and the program logic 1359. The decision engine 1357 and the program logic 1359 determine that $150 will be applied to the MasterCard account level 1369a, and $250 should be applied to the personal loan account level 1369b. In this example, factors such as account and customer risk, security (collateral) for the loan, and potential recourse in the event of default, may be used to determine how the funds should be applied. The new account level customer offer amounts are rolled up from the account levels to the higher intervening levels (if any), such as the illustrated group levels 1367a, 1367b in the customer hierarchy.

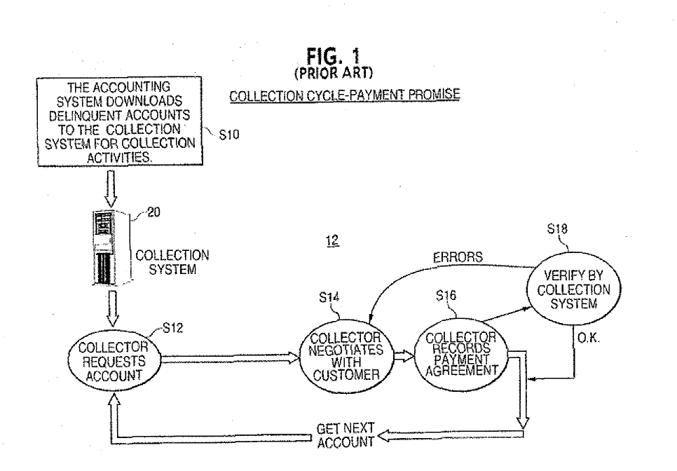

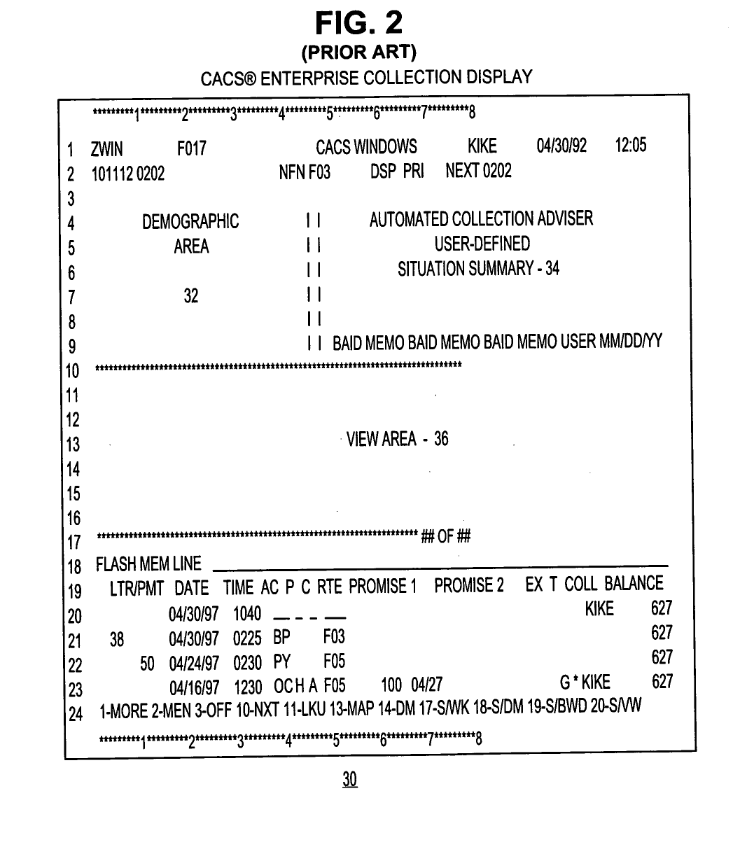

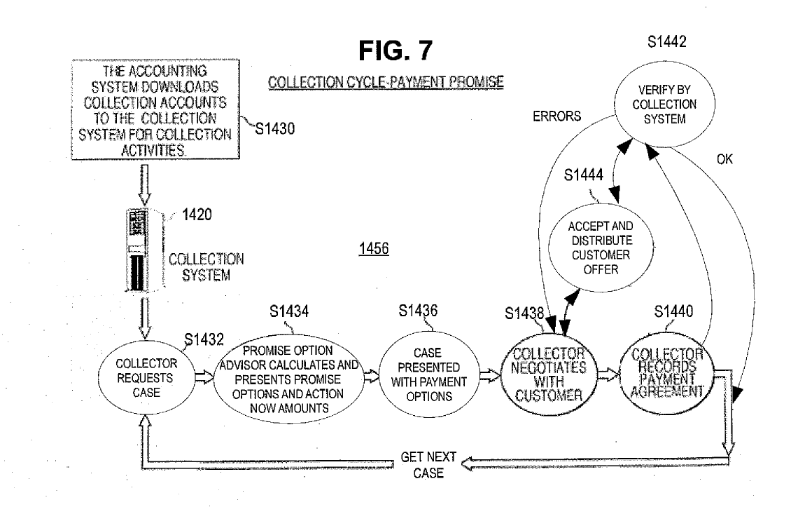

Referring now to FIG. 7, an illustration of a flowchart of a collection cycle including case based promises to pay will be discussed and described. In the flowchart 1456 of FIG. 7, operations S1430, S1438, S1440, and S1442 correspond, respectively, to operations S10, S14, S16, and S18 of the collection cycle of the related art, shown in FIG. 1, the explanation of which is not repeated herein. The collection system 1420 shown in FIG. 7 is the same as the related collection system 20 shown in FIG. 1.

However, in the illustrated flowchart 1456 of FIG. 7, operations S1432, S1434, S1436 and S1444 are added using the promise management system. In operation S1432 the collector requests a case, which can include plural “accounts” discussed in connection with FIG. 1. In operation S1434, the promise option advisory module, included in the promise management system, calculates and presents to the user using the promise management action dialog and action now dialog described herein. Then, in operation S1436, the case is presented to the user (such as the collector) with payment options, by the promise management system. Therefore, before the collector negotiates S1438 with the account holder, the collector is proactively provided with promise options and action now amounts for plural accounts in the case. In negotiating with the account holder, the collector can optionally input a customer offer S1444, and a distribution of the customer offer to levels below is determined. The promise options and customer offer can be verified by the collection system if submitted to the collection system for such verification in operation S1442.

In operation S1432, the collector requests a case, whereas in previous systems, the collector requests an account. In operation S1434, the promise option advisor calculates and presents promise options and an action now amount for the accounts in the case, whereas in previous systems, the promise option advisor calculates and presents promise options for an account. In operation S1436, the case is presented with payment options, whereas in previous systems, the account is presented with payment options. In S1438, optionally, a customer offer from the customer results in operation S1444 accepting and distributing the customer offer.

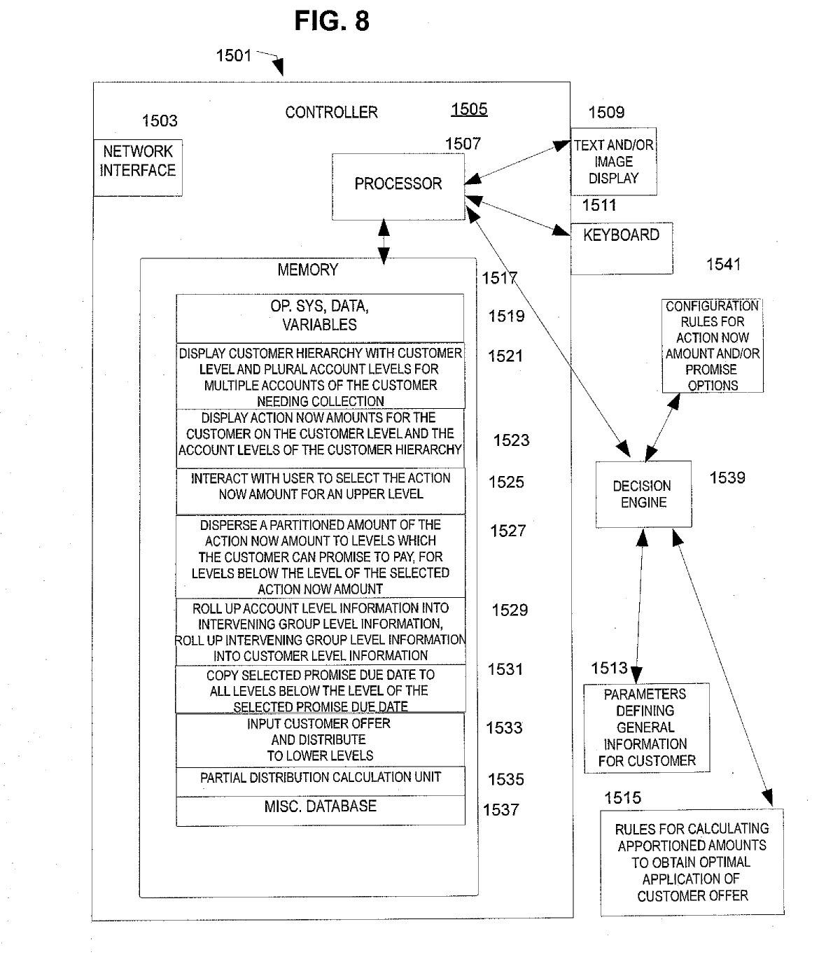

Referring now to FIG. 8, a block diagram illustration portions of an exemplary computer system will be discussed and described. The computer system 1501 may include a network interface 1503 and one or more controllers 1505. The network interface 1503 can be any conventional network interface, and may be wireless or wired. The controller 1505 may include a processor 1507, a memory 1517, and other optional components which will be well understood to those in this field. A text and/or image display 1509 and a keyboard 1511 and/or other display and input device for interacting with the user, such as a track ball, console, keypad, and/or similar can also be provided with the computer system 1501.

The processor 1507 may be, for example, one or more microprocessors and/or one or more digital signal processors. The memory 1517 may be coupled to the processor 1507 and may comprise a read-only memory (ROM), a random-access memory (RAM), a read/write flash memory, a programmable ROM (PROM), and/or an electrically erasable read-only memory (EEPROM). The memory 1517 may include multiple memory locations for storing, among other things, an operating system, data and variables 1519 for programs executed by the processor 1507; computer programs for causing the processor to operate in connection with various functions such as displaying 1521a customer hierarchy, displaying 1523 action now amounts for the customer, interacting 1525 with the user to select action now amounts, dispersing 1527 a partitioned amount of the action now amount, rolling up 1529 account level information, and copying 1531 selected promise due dates; and a database 1537 of various information used by the processor 1507. The computer programs may be stored, for example, in ROM or PROM and may direct the processor 1507 in controlling the operation of the computer system 1501. Each of these computer programs is discussed by way of example below.

The processor 1507 may be programmed for displaying 1521a customer hierarchy. That is, a user interface can be displayed with a customer hierarchy for a case. The customer hierarchy includes customer level data and data for plural account levels for multiple accounts of the customer which need collection. The customer hierarchy can include a customer level (sometimes referred to herein as a case level), one or more account levels, and one or more levels of groups intervening between the case level and account levels, as previously explained.

Further, the processor 1507 may be programmed for displaying 1523 action now amounts for the customer. The action now amounts for the customer can be displayed on the customer level and the account levels of the customer hierarchy, as well as any intervening levels of the customer hierarchy. The action now amounts for levels above the account level are calculated from the lower levels, as described above. The action now amounts for the account levels can be obtained from, for example, a decision engine 1539 as discussed herein in more detail.

The processor 1507 may be programmed for interacting 1525 with the user to select action now amounts. This has been described in detail above in connection with FIGS. 5A-D and FIGS. 6A-1.

The processor 1507 also can be programmed for dispersing 1527 a partitioned amount of the action now amount. That is, an action now amount which the customer can promise to pay is selected. A partitioned amount of the selected action now amount to be dispersed to the lower account levels is determined, and is dispersed to those levels which are below the level of the selected action now amount. (The term “below” and “above” are used herein from the perspective of the customer hierarchy, and refer to children and ancestor nodes, as distinguished from visual levels.)

Also, the processor 1507 can be programmed for rolling up 1529 account level information. For example, if a customer hierarchy includes account levels and group levels, the account level information is rolled up to higher levels in the customer hierarchy. For example, the account level information is rolled up into the intervening group level information, and the intervening group level information is rolled up into customer level information. Account level information which is a financial amount is rolled up by being added, whereas dates are rolled-up by using the nearest chronological date. The rolled-up amounts can be displayed on a user interface.

The processor 1507 can be programmed for copying 1531 selected promise due dates. As described above in more detail, if a promise due date for an intervening level or a customer level is selected, the selected promise due date can be stored as the promise due date for levels below the level of the selected promise due date, down to and including the lower account levels.

Optionally, the processor 1507 can be provided with additional functions and/or enhancements, such as inputting 1533 a customer offer. That is, a customer offer of a partial amount (that is, less than the action now amount) can be input, and can be distributed to lower levels in the customer hierarchy. Because there is a partial amount to be distributed to the lower levels, a partial distribution amount can be calculated as described herein.

The processor 1507 also can be programmed with a partial distribution calculation unit 1535. The partial distribution can be calculated as described above, optionally in connection with the decision engine 1539.

Moreover, a computer-readable medium may include instructions for execution by a computer, the instructions including a computer-implemented method for managing case based promises to pay.

Also illustrated is the database 1537 of various information used by the processor 1507. The database 1537 is provided for local storage of information. For example, the database 1537 can be used for storing some or all of the data currently being used for a current case.

The computer system 1501 can interact with the decision engine 1539, which can be remote or local, or optionally can be part of the computer system 1501. The decision engine 1539 can be used to determine an action now amount, promise options, a partitioned amount of the action now amount to be dispersed to levels which are hierarchically below the level of the selected action now amount in the customer hierarchy, and/or a partial distribution based on a customer offer amount. The decision engine 1539 can use the case data and can interact with parameters 1513 which are particular to each customer and which define general information for the customer, and/or with rules 1515 which are used for calculating apportioned amounts to obtain optimal application of the customer offer, and/or with configurable rules for the action now amount and/or promise options.

It should be understood that various embodiments are described herein in connection with logical groupings of functions. One or more embodiments may omit one or more of these logical groupings. Likewise, in one or more embodiments, functions may be grouped differently, combined, or augmented.

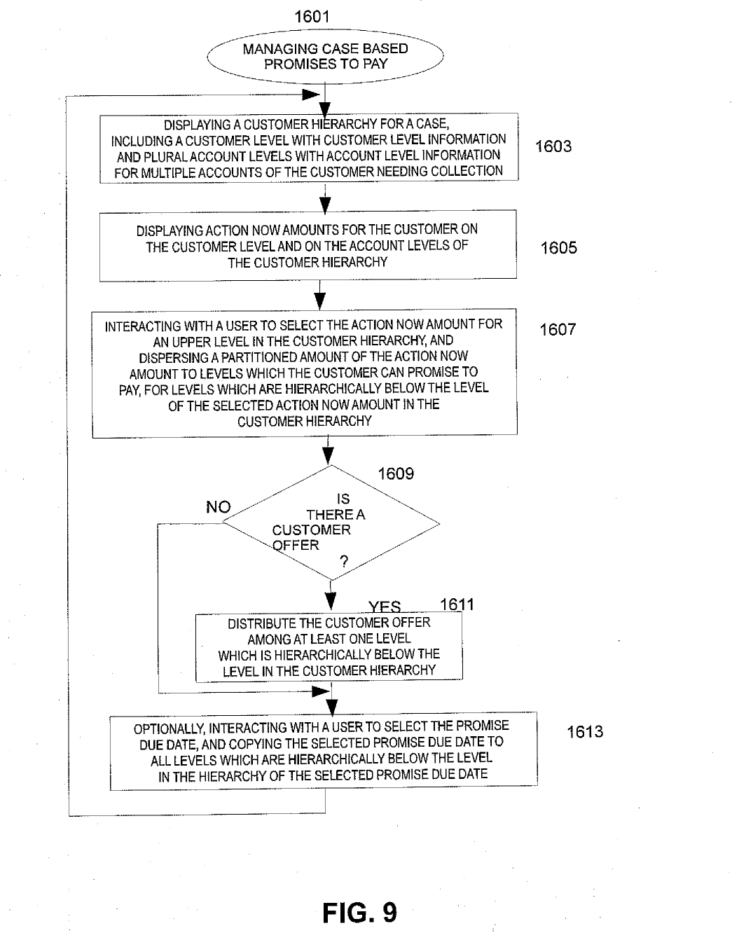

Referring now to FIG. 9, a flowchart illustrating an exemplary procedure for managing case based promises to pay will be discussed and described. The procedure can advantageously be implemented on, for example, a processor of a computer system, described in connection with FIG. 8 or other apparatus appropriately arranged.

In overview, the procedure 1601 for managing case based promises to pay includes displaying 1603 a customer hierarchy for a customer; displaying 1605 action now amounts for the customer, interacting 1607 with a user to select an action now amount for an upper level of the customer hierarchy, if 1609 there is a customer offer then distributing 1611 the customer offer, and optionally interacting 1613 with a user to select a promise due date and copying the promise due date. These are now discussed further. However, many of the functions discussed in connection with the procedure 1601 for managing case based promises to pay have been described above in detail, and such discussion will not be repeated below.

The procedure 1601 includes displaying 1603 a customer hierarchy for a case. The displayed customer hierarchy includes at least a customer level with customer level information and plural account levels with account level information. Various intervening levels between the customer level and the account levels can be included, for example a group level, a sub-group level, and so on. The accounts which are displayed at the account level include those accounts of the customer which need collection. Accordingly, the group of these accounts at the customer level, all of which are related to the customer, can be referred to as a “case.”

The procedure 1601 includes displaying 1605 action now amounts for the customer. The action now amounts which are displayed are at the customer level, the account levels, and any intervening group levels of the customer hierarchy. The action now amounts are determined as described herein.

The procedure 1601 includes interacting 1607 with a user to select an action now amount for an upper level of the customer hierarchy. More particular, an action now amount for one of the upper levels in the customer hierarchy can be selected, and a partitioned amount of the action now amount can be dispersed to levels which the customer can promise to pay, for those levels which are hierarchically below the level of the selection action now amount in the customer hierarchy.

The procedure 1601 includes, if 1609 there is a customer offer, then distributing 1611 the customer offer. The customer offer can be distributed among at least one level which is hierarchically below the level in the customer hierarchy.

The procedure 1601 includes optionally interacting 1613 with a user to select a promise due date and copying the promise due date. In particular, the selected promise due date is copied to all levels which are hierarchically below the level of the selected promise due date.

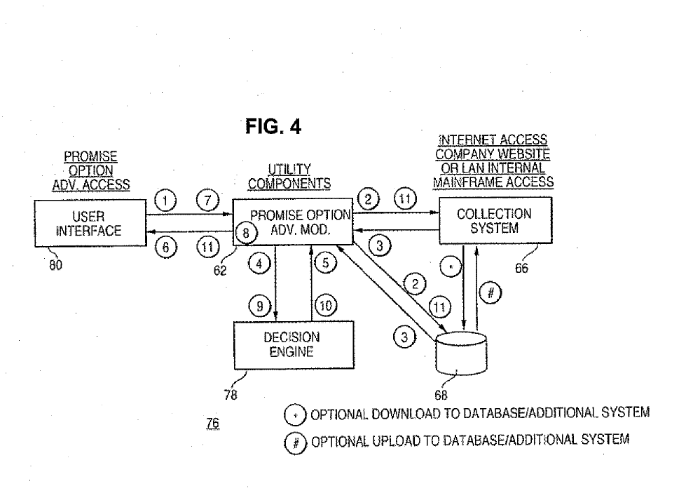

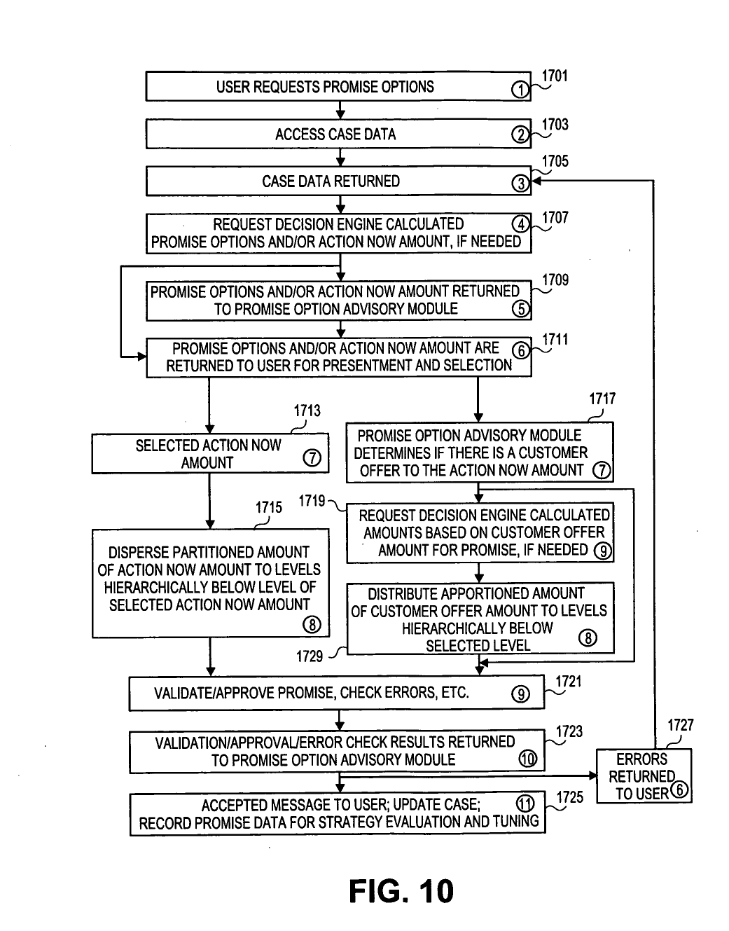

Referring now to FIG. 10, a flowchart illustrating a data flow will be discussed and described. Reference also is made to FIG. 4, a data flow diagram showing data flow in a preferred architecture of a computer system 76 implementing the promise option advisory module 62. FIGS. 4 and 10 are explained jointly in the following paragraphs, and in the following explanations of FIGS. 4 and 10, encircled numerals indicate data explained in FIG. 10 being passed between the promise option advisory module 62, Decision Engine 78, the database 68, the collection system 66, and the company web site 80, in the direction(s) shown in FIG. 4.

Access to case-based promises in the promise option advisory module access is established through a user interface 80, preferably a GUI interface. As further described above, FIG. 4 illustrates the promise option advisory module 62, the decision engine 78, and the database 68, which are referred to as utility components of the promise management system. The collection system 66 interfaces to the promise option advisory module 62 by a mainframe access, by internet access, or through a LAN (local area network) internal access. Data is passed between the promise option advisory module 62 and the decision engine 78, the user interface 80, the collection system 66, and the database 68 using, for example, a well-defined application program interface (API). Other configurations for a system architecture can be used in other embodiments.

As shown in FIGS. 4 and 10, a user in operation 1701 through a user interface 80 requests promise options from the promise option advisory module 62. Next, in operation 1703, the promise option advisory module 62 accesses case data which can be stored in the database 68 included in a database server or in collection system 66. The database 68 is populated with the case data downloaded from the collection system 66 to the database 68. The case data are the account data (discussed above) for the customer. The database 68 can be part of an additional computer system.

The case data, which are retrieved by the collection system 66, are returned to the promise option advisory module 62, as shown in operation 1705. In operation 1707, the promise option advisory module requests the decision engine 78 to calculate promise options and/or action now amounts, if needed. The action now amounts and promise options are preferably calculated on the fly from the case data, which optionally can be cached, or can be re-calculated when case data for the customer is updated, modified, deleted, or added. If the promise option advisory module 62 requests that the decision engine 78 calculate the promise options and action now amounts in operation 1707, the decision engine 78 returns the calculated promise options and action now amounts to the promise option advisory module 62, in operation 1709. If the promise option advisory module 62 does not request that the decision engine 78 calculate the promise options and action now amounts, then control proceeds directly to operation 1711. In operation 1711, the calculated promise options and action now amounts are returned to the user for presentment and selection. The user then can select an action now amount (action now operation sequence 1713, 1715) or can optionally input a customer offer amount alternative to the action now amount (customer offer operation sequence 1717, 1719, and 1729).

In the action now operation sequence, the user selects an action now amount in operation 1713, and the selected action now amount or promise option agreed to by the user is transmitted to the promise option advisory module 62. The promise option advisory module then determines a partitioned amount of the action now amount, and disperses the partitioned amount of the action now amount to levels hierarchically below the level of the selected action now amount in operation 1715.

In the customer offer operation sequence, in operation 1717, the promise option advisory module determines if there is a customer offer to the action now amount. If there is a customer offer, then at operation 1719 the promise option advisory modules requests calculated amounts from the decision engine, where the amounts are based on the customer offer amount for a promise. Then, in operation 1729, the promise option advisory module determines an apportioned amount of the customer offer amount, and distributes the apportioned amount of the customer offer amount to levels hierarchically below the level of the action now amount for which the customer offers a customer offer.

Then the promise option/data and/or action now amounts from the action now operation sequence 1713, 1715 or the apportioned amount of the customer offer amount from the customer offer sequence 1717, 1719, 1729 are passed to the decision engine 78 for acceptability and tolerance checking, in operation 1721. In operation 1723, the validation results are returned to the promise option advisory module 62. If the validation results contain errors, the errors are returned to the user in operation 1727.

If the validation results do not contain errors then, in operation 1725, an accepted message is sent to the user via the user interface 80, the customer's case is updated, preferably, in the database 68 or in the collection system 66, and the promise data (perhaps as modified by a customer offer) is recorded for strategy evaluation and tuning in database 68. The customer's case data is transmitted between the collection system 66 and the database 68, as shown in FIG. 4, to reconcile the data stored in the collection system 66 and the database 68.

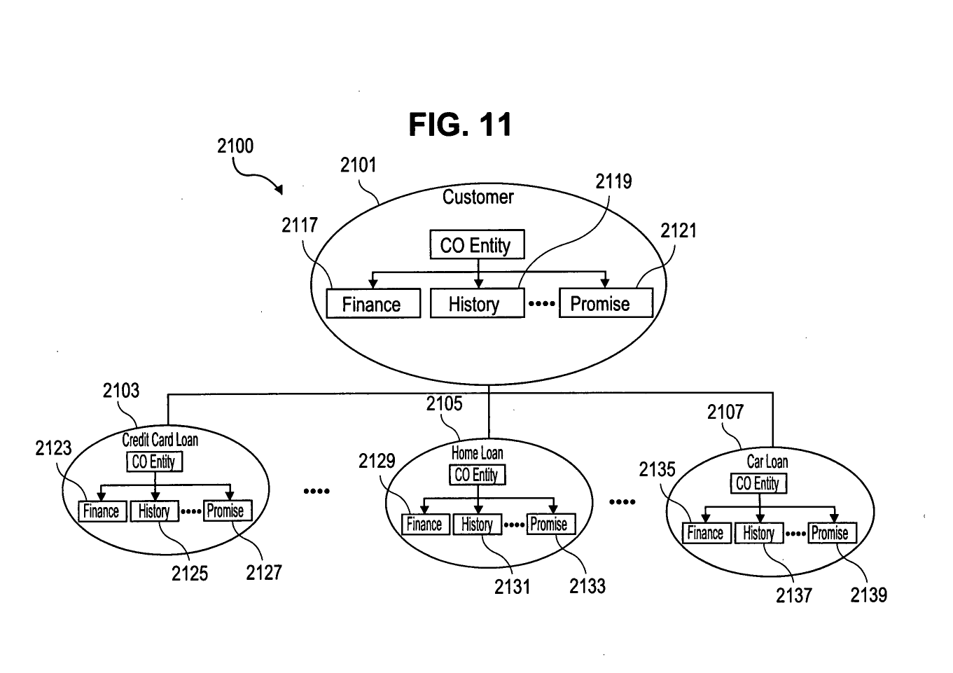

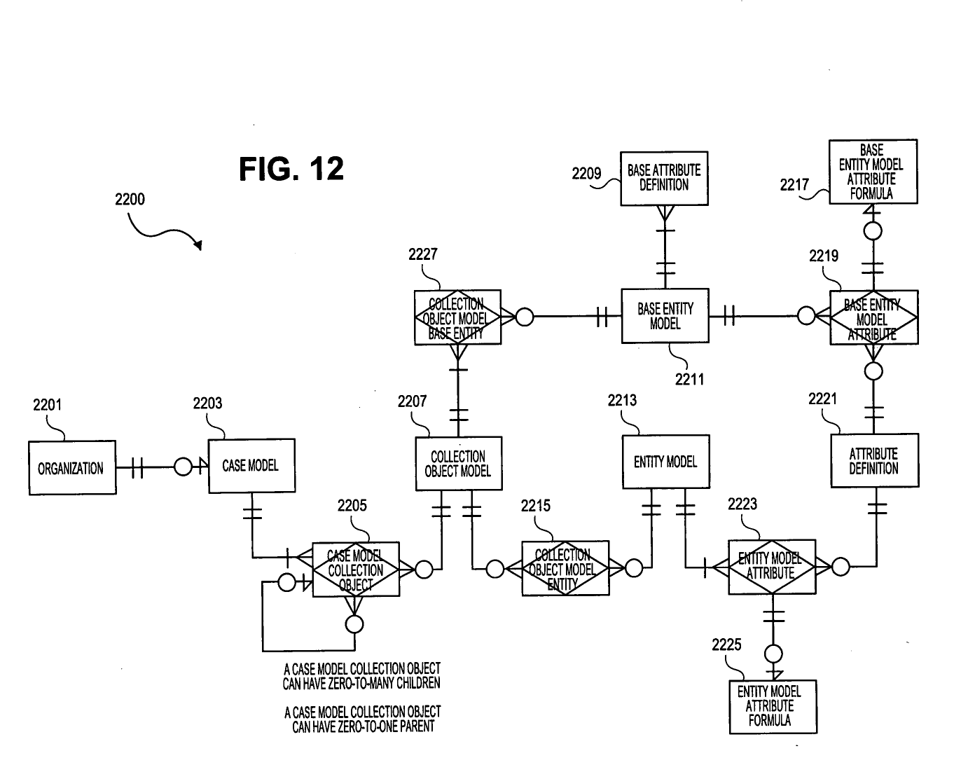

Having now considered potential user interfaces to access collections data for a customer's case and to manage payment promises, a structure for creating and managing a flexible case model for use in managing collections of multiple accounts of a customer will now be explored. FIG. 11 provides an example of a case model hierarchy which might be used by a bank, whereas FIG. 12 provides a definition of the flexible entity data model. The flexible entity data model allows the definition of collection object models and the relationship of collection object models within a case model hierarchy.

Referring now to FIG. 11, an illustration of a case model hierarchy will be discussed and described. A case model hierarchy 2100 includes collection object models 2101, 2103, 2105, 2107. Each of the collection object models 2101, 2103, 2105, 2107 can include a finance entity model 2117, 2123, 2129, 2135, a history entity model 2119, 2125, 2131, 2137, and a promise entity model 2121, 2127, 2133, 2139. Optionally, other entity models can be included in a collection object model.

A case, which is a grouping of collections data related to a customer, can be defined using the case model hierarchy 2100. The case model hierarchy 2100 applies its structure to the data in the collection system such that an organization can create a hierarchy of customers and accounts that define cases in a way that is appropriate for the organization. The case model hierarchy 2100 can be extended in depth and breadth, to allow for the addition of any number of new types of customers and accounts.

In FIG. 11, the case model hierarchy 2100 is simplified and is intended to represent accounts of interest with respect to a customer, including accounts for a credit card loan, a home loan, and a car loan, all owned by the customer. The case model hierarchy 2100 includes two levels, that is a customer level and an account level, although more are possible as discussed above for example in connection with FIGS. 6A-6E.

The collection object models 2101, 2103, 2105, 2107 in the case model hierarchy 2100 include the same entity models. The case model hierarchy 2100 is defined to include a customer collection object model 2101, which can have zero-to-many children. In this case, the children of the customer collection object model 2101 can include a credit card loan collection object model 2103, a home loan collection object model 2105, and a car loan collection object model 2107.

The case model hierarchy 2100 generally represents an organization's view of its collection relationship with its customers. A case is a particular instance of the case model hierarchy which represents a particular customer.

The collection object model at the customer level represents an overall collection of accounts which need collection. Each of the collection object models at the account level represents an account of the customer which needs collection, e.g., a credit card loan. A collection object is a particular instance of the collection object model for a particular customer. A collection object (at the account level) is an instance of the collection object model for a particular account of a particular customer.

At the account level, the finance entity model 2117, 2123, 2129, 2135 represents balance due or other finance data for the account. The history entity model 2119, 2125, 2131, 2137 represents actions taken against the account, for example, contacting the customer, payments, bills, and the like. The promise entity model 2121, 2127, 2133, 2139 represents a customer's commitment to pay (including one or more amounts and dates). At the account level, the data source for the entities includes the individual collection records (for the customer) in the collection system. An entity is a particular instance of the entity model in a collection object.

At the levels above the account level (here, the customer level), the entities are calculated from the lower levels. Thus, the finance entity 2117 of the customer level collection object 2101 is determined from the finance entities 2123, 2129, 2135 of the credit card loan collection object 2103, the home loan collection object 2105, and the car loan collection object 2107; the history entity 2119 of the customer level is determined from the history entities 2125, 2131, 2137 of the credit card loan, home loan, and car loan collection objects 2103, 2105, 2107; and the promise entity 2121 of the customer level is determined from the promise entities 2127, 2133, 2139 of the credit card loan, home loan, and car loan collection objects 2103, 2105, 2107. If a case model hierarchy includes intervening levels, these two are calculated from the lower levels, and the customer level is calculated from the intervening levels.

There are two types of entity models: base entity models and custom entity models. Base entity models are defined to always exist in a collection object model. Example base entity models include a finance entity model, a promise entity model, and a history entity model. Base entity models can optionally be defined to include a securitization entity model to contain data reflecting securitization. Custom entity models may or may not exist in a collection object model, and include for example a collateral entity model included in a car loan collection object model.

Each entity model includes one or more attribute models, discussed in more detail below. Data on the entity models can be rolled up, so that the upper level data is determined from the lower level data. More particularly, the case model hierarchy 2100 permits the roll-up of data from the account level or any lower levels to higher levels. Advantageously, this can prevent needlessly maintaining information which can be calculated from the actual accounts which need collection.

Referring now to FIG. 12, an illustration of a flexible entity data model will be discussed and described. A flexible entity data model 2200, here illustrated in Barker's notation, permits a user to define a case model hierarchy which is customized to reflect an organization or enterprise's collection relationship with its customer. At the top level is an organization 2201 which can be associated to zero or one case model 2203. The case model 2203 is comprised of one to many collection object models 2207 via the case model collection object association 2205. The structure of a case model hierarchy can be defined by creating parent-child relationships between the case model collection objects 2205 for a particular case model 2203. A case model collection object 2205 can have zero-to-many other case model collection objects 2205 and can also have zero to one parent case model collection objects 2205.

A collection object model 2207 can be associated to zero-to-many collection object models 2203 via the case model collection object 2205 association. A collection object model 2207 can be associated to zero to many case models 2203 via the collection object model entity association 2215. A collection object model 2207 is comprised of one to many base entity models 2211 via the collection object model base entity association 2227.

An entity model 2213 can be associated to zero to many collection object models 2207 via the collection object model entity 2215 association. An entity model 2213 is comprised of one to many attribute definitions 2221 via the entity model attribute 2223 association.

An attribute definition 2221 can be associated to zero to many entity models 2213 via the entity model attribute 2223 association. An attribute definition 2221 can be associated to zero to many base entity models 2211 via the base entity model attribute 2219 association. Each attribute definition 2221 that has a calculated type data source and is associated with an entity model 2213 can have an entity model attribute formula 2225 defined. Each attribute definition 2221 that has a calculated type data source and is associated to a base entity model 2211 must have a base entity model attribute formula 2217 defined.

A base entity model 2211 can be associated to zero to many collection object models 2207 via the collection object model base entity 2227 association.

A base entity model 2211 is comprised of one to many base attribute definitions 2209. A base attribute definition 2209 can be associated to one and only one base entity model 2211. A base entity model 2211 is comprised of one to many attribute definitions 2221.

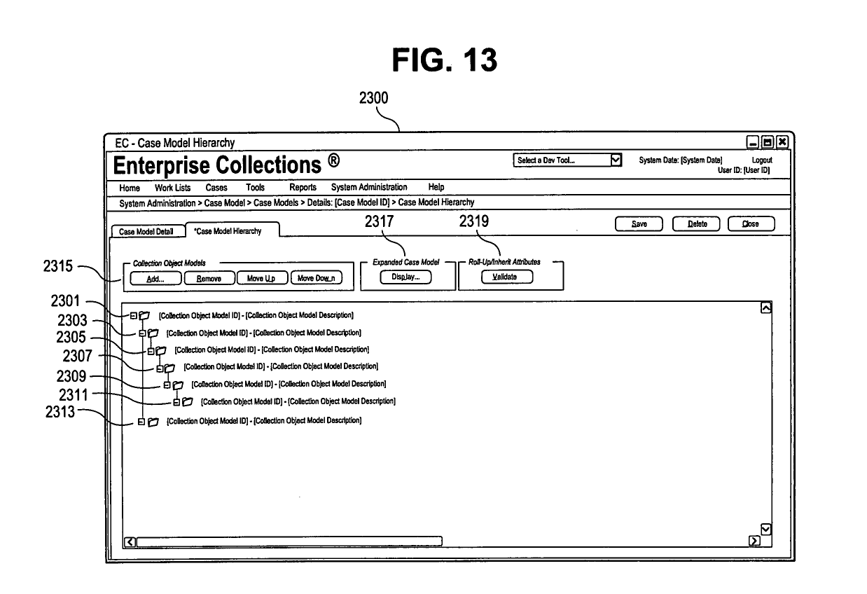

Referring now to FIG. 13, an illustration of a user interface for a case model hierarchy creation will be discussed and described. A user interacts with the illustrated user interface 2300 to place one or more collection object models into a case model hierarchy. Collection object models 2301, 2303, 2305, 2307, 2309, 2311, 2313 are placed in the order in which they are to be displayed. The collection object models can be added, removed, moved up, and/or moved down in the case model hierarchy. For an actual case, however, the user interface can display only actual instances in the case.

The user interface 2300 illustrated in FIG. 13 also includes a “Validate” selection button 2319, to allow a user to validate whether there is a contiguous string of roll-up or inherit hierarchy. If the string is not contiguous, an error message can be provided.

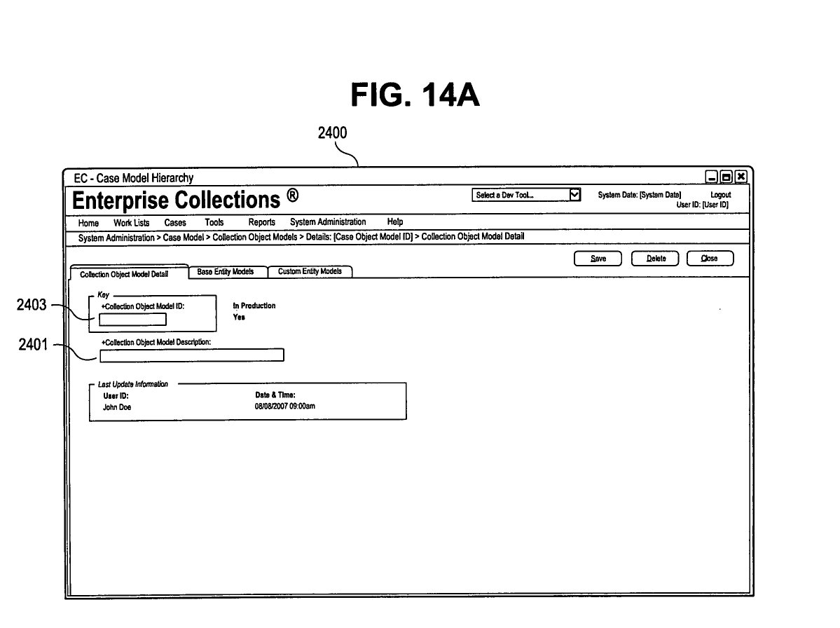

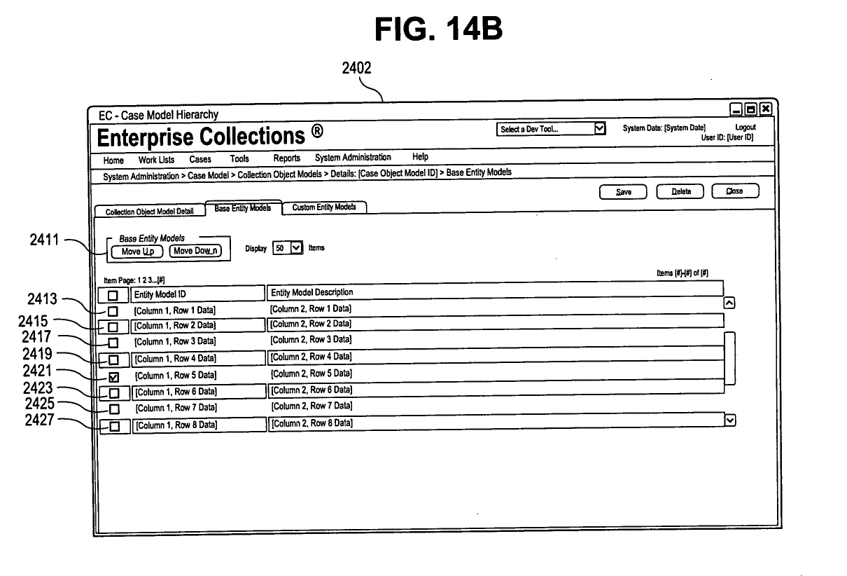

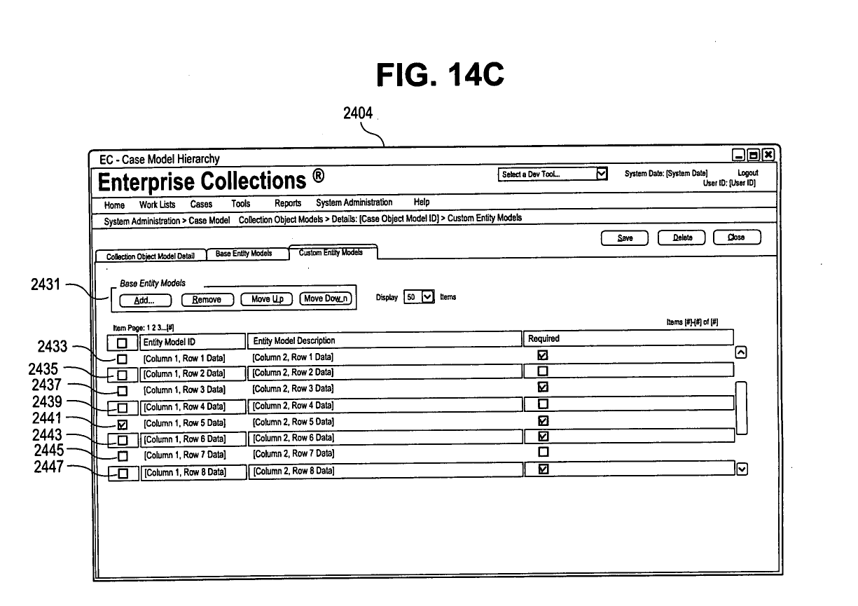

Referring now to FIG. 14A to FIG. 14C, illustrations of user interfaces for the collection object model will be discussed and described. The example user interfaces in these figures illustrate defining a collection object model identifier and a description for a collection object model. In FIG. 14A, a user interacts with the illustrated user interface 2400 to define a collection object model. Here, the user interface 2400 can receive indications of the collection object model identifier 2403 and the collection object model description 2401. In FIG. 14A, note that the “In Production” status is “Yes”; the status could be “Draft,” for example, to indicate whether the model is a draft or is actually in production.

With reference back to FIG. 13, selecting a different collection object model 2301, 2303, 2305, 2307, 2309, 2311, 2313 can initiate a user interface for the collection object model, similar to FIG. 14A.

In FIG. 14B, a user interacts with the illustrated user interface 2402 to view the base entity models that are associated to the collection object model. Here, the user views the base entity models 2413, 2415, 2417, 2419, 2421, 2423, 2425, 2427 associated with the collection object model. A “Move up/Move down” selection button 2411 is provided to permit a user to move or re-order the base entity models 2413, 2415, 2417, 2419, 2421, 2423, 2425, 2427 within the collection object model. Although this example lists eight base entity models, any number of base entity models can be provided.

In FIG. 14C, a user interacts with the illustrated user interface 2402 to associate custom entity models to the collection object model. Here, the user associates custom entity models 2433, 2435, 2437, 2439, 2441, 2443, 2445, 2447 with the collection object model. An “Add/Remove/Move up/Move down” selection button 2411 is provided to permit a user to add, remove, move or re-order the custom entity models 2413, 2415, 2417, 2419, 2421, 2423, 2425, 2427 within the collection object model.

In the illustrated example, the user is not permitted to add or remove base entity models (FIG. 14B), although the user can add or remove custom entity models. However, other implementations might permit a user, such as with appropriate privileges, to add or remove base entity models.

Also referring back to FIG. 13, a user can interact with the user interface so that any of the collection object models 2301, 2303, 2305, 2307, 2309, 2311, 2313 can include collection object models, and any of those included collection object models can themselves include collection object models.

The user can interact with the user interface so that the collection object models are further defined to contain entity models, including one or more base entity models, and zero or more custom entity models.

The user can interact with the user interface so that each of those entity models can be defined to include an attribute, where the attribute is at least a data source. The attribute optionally can include an attribute description, a data type, and a format. At the account level or any lower levels, the data source can be a location in a collection record where the data for the account of a customer is located. At any level, the data source can be a definition of a record in a database, a program which will fetch the data from the database, a formula for calculating the data with reference to the foregoing, a roll-up (which defines a summation of attributes on lower levels in the case model hierarchy), an inherit action (which inherits a value from the high level in the case model hierarchy), a date difference, or a date calculation. Other definitions of a data source can include Boolean logic calculation, numeric calculation, calling a userexit routine, or an attribute from a database.

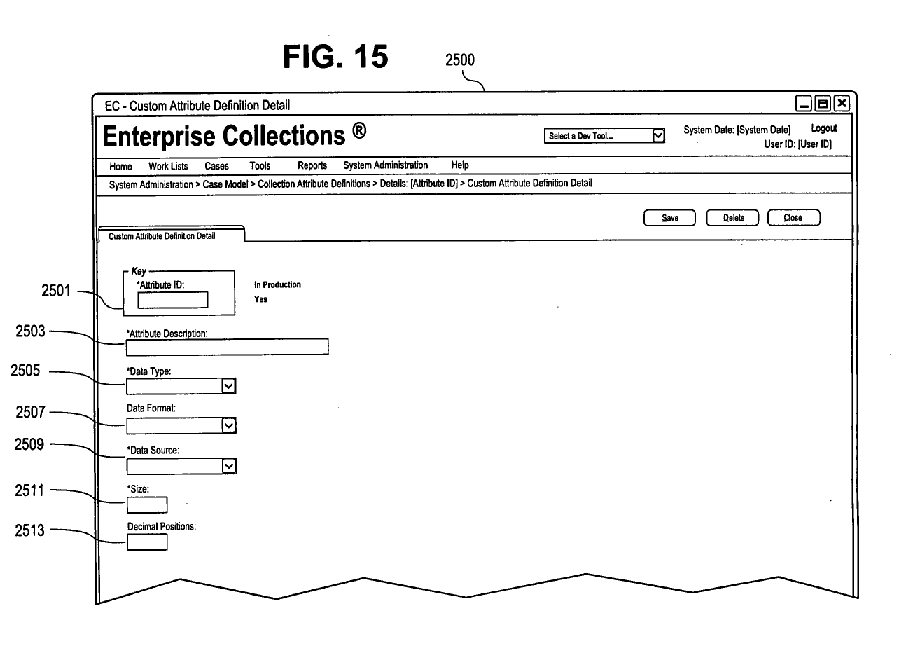

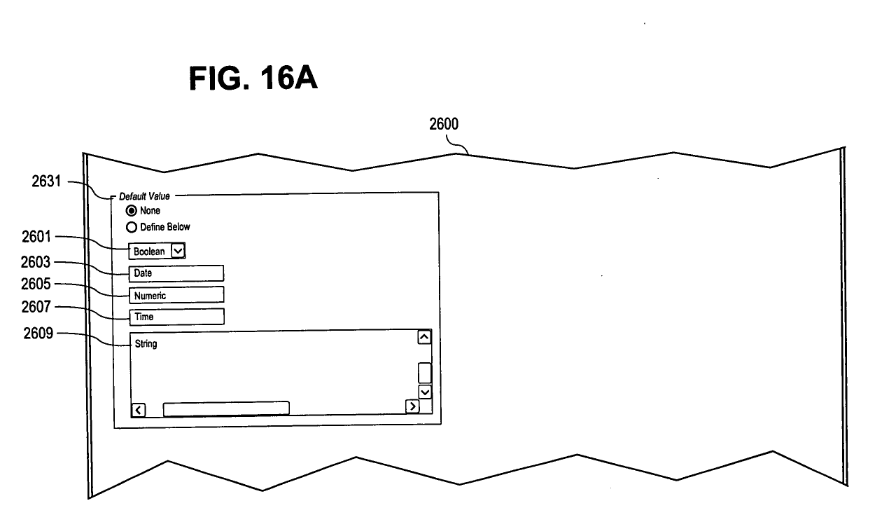

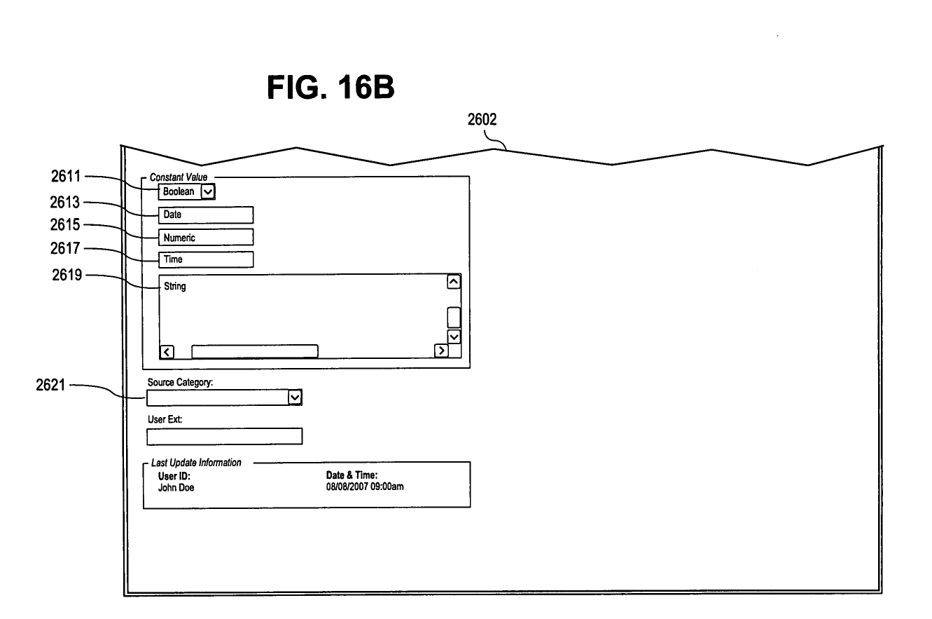

An example of interacting with a user to define an attribute is provided in connection with FIGS. 15 and 16a-b, where FIG. 15 is the top half of a user interface, and FIGS. 16a and 16b are the bottom half of the user interface.

Referring now to FIG. 15, an illustration of a top of a user interface for an attribute detail will be discussed and described. The user interface 2500 is directed toward detailing a custom attribute definition, and can include an attribute identifier 2501, an attribute description 2503, a data type 2505, a data format 2507, a data source 2509, a size 2511, and decimal positions 2513. Fields marked with an asterick such as the data source 2509 are required.

Referring now to FIG. 16A to FIG. 16B, illustrations of a middle and bottom of the user interface for an attribute detail will be discussed and described. The user interface 2600 includes a selection of default value 2631. The user can select whether the attribute has a default value. If a default value is to be defined, the respective input field (a Boolean indicator 2601, a date value 2603, a numeric value 2605, a time value 2607, or a string 2609), which is based on the data type of the attribute being defined, is displayed to the user. FIG. 16B further illustrates selection of constant value. If the data source of the attribute being defined is “Constant”. The constant value group provides the user the ability to enter the constant value for the attribute. The respective input field (including a Boolean indicator 2611, a date value 2613, a numeric value 2615, a time value 2617, or a string 2619), which is based on the data type of the attribute being defined, is displayed to the user. Also included is a source category 2621. The custom attribute definition details provide great flexibility in defining each case model hierarchy.

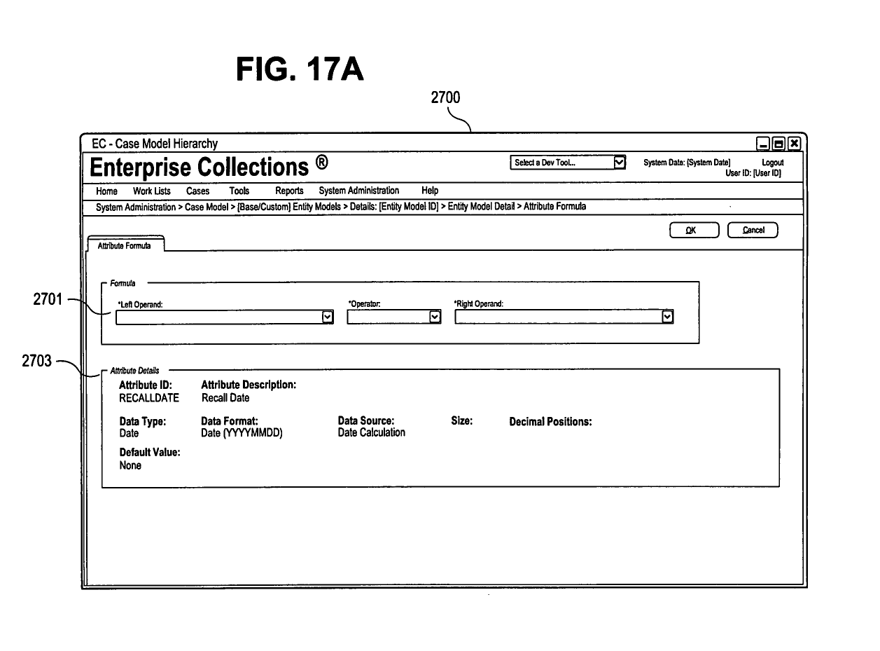

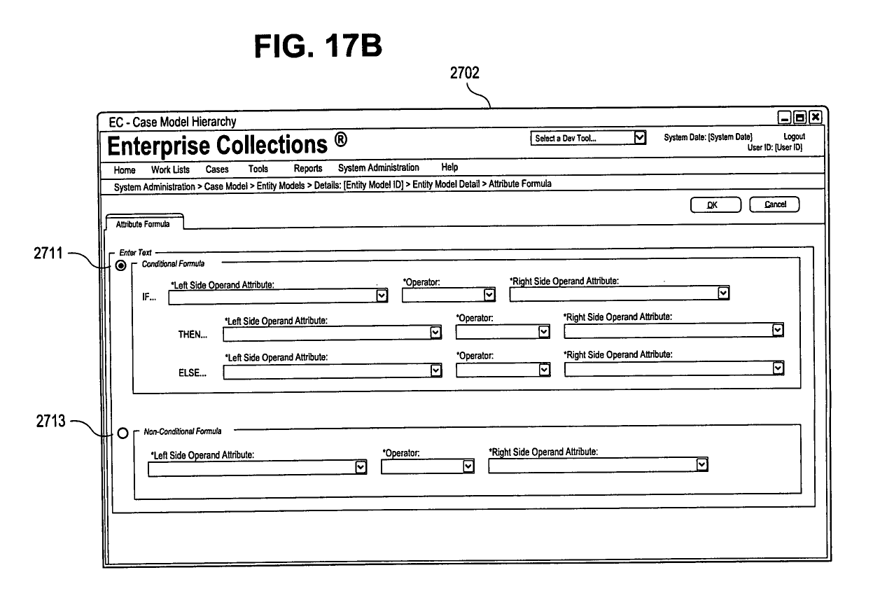

FIG. 17A provides an illustration of a preferred user interface for an attribute formula. FIG. 17B is an alternate user interface for an attribute formula which uses conditionals. Each is described below.

Referring now to FIG. 17A, an illustration of a user interface for an attribute formula will be discussed and described. Here, the user can interact with the user interface 2700 to define a formula for an attribute, if a formula is used for that attribute. In this embodiment, the formula is an operation 2701, with a left operand, a right operand, and an operator, where an attribute data source is a right or left operand.

Referring now to FIG. 17B, an illustration of an alternate user interface for an attribute formula will be discussed and described. Here, the user can interact with the user interface 2702 to define a formula for an attribute, if a formula is used for that attribute. In this embodiment, the formula is conditional 2711 or non-conditional 2713. In the conditional or non-conditional formula 2711, 2713, the user can specify an attribute data source as an operand. Although not shown in FIG. 1713, the alternate formula user interface 2702 also displays, underneath the non-conditional formula 2713, the Attribute Details group 2703 as shown in FIG. 17A.

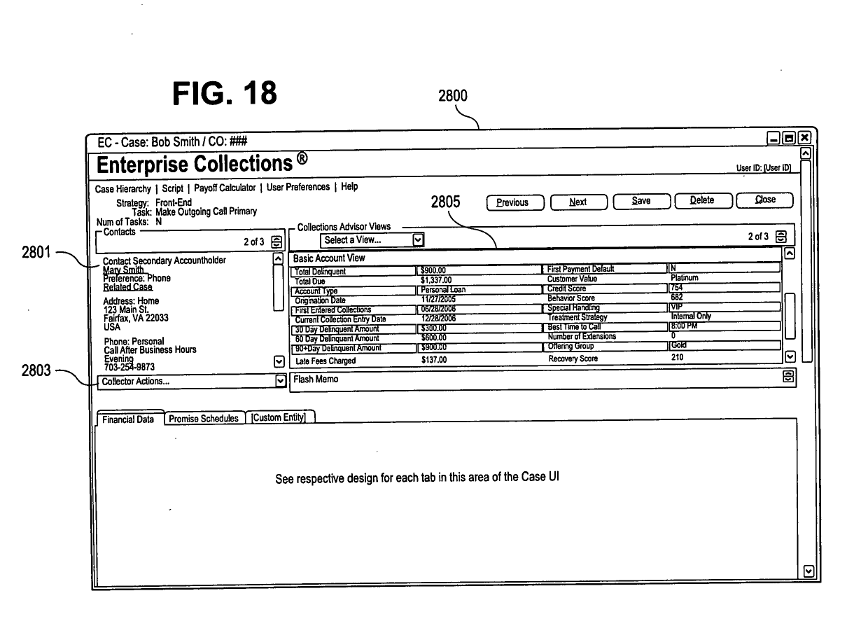

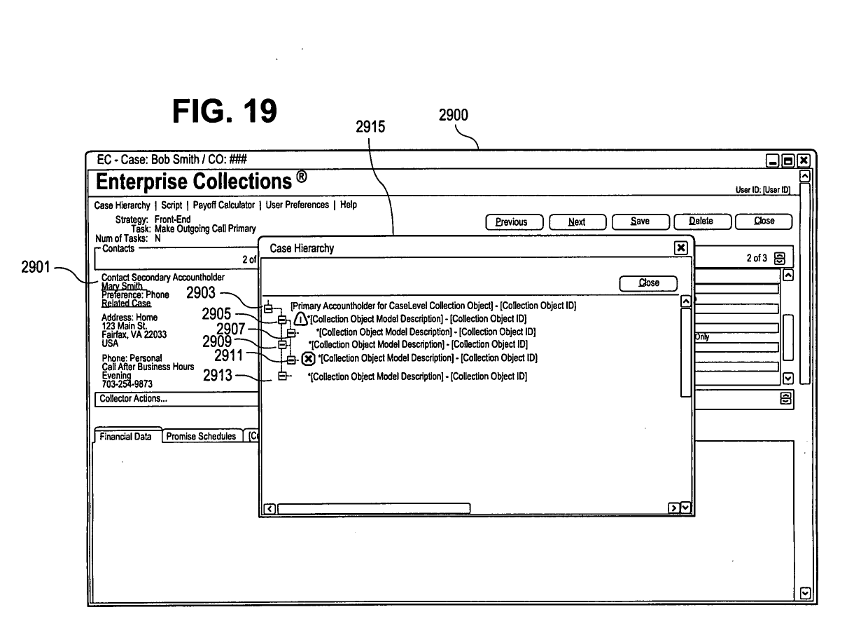

FIGS. 18 and 19 together provide an illustration of a user interacting with a collection object for a particular case, that is, the accounts for “Bob Smith.”

Referring now to FIG. 18, an illustration of a user interface for a collection object page will be discussed and described. The user interface is at an account level in the case hierarchy, where the summary view of the collection object 2805 for one of the “Bob Smith” accounts is displayed, as well as contact information 2801. Note that one or more contacts can be provided, such as the secondary contact “Mary Smith” which is being displayed as the contact information 2801, and/or a skip trace contact entity to provide contact information in the event of a skip trace. The illustrated collection object is a personal loan collection object. The collection records for the personal loan are the data source to provide a finance entity.

When a user selects the “case hierarchy” button, the overall case hierarchy is displayed, for example, as shown in FIG. 19.

Referring now to FIG. 19, an illustration of a user interface case hierarchy in which collection object resides will be discussed and described. The illustrated overall case hierarchy 2915 includes a primary account holder for a case level collection object 2903, and collection object models 2905, 2907, 2909, 2911, 2913. The display of the overall case hierarchy 2915 can be provided for the assistance of the collector and for navigating to other collection objects in the case.

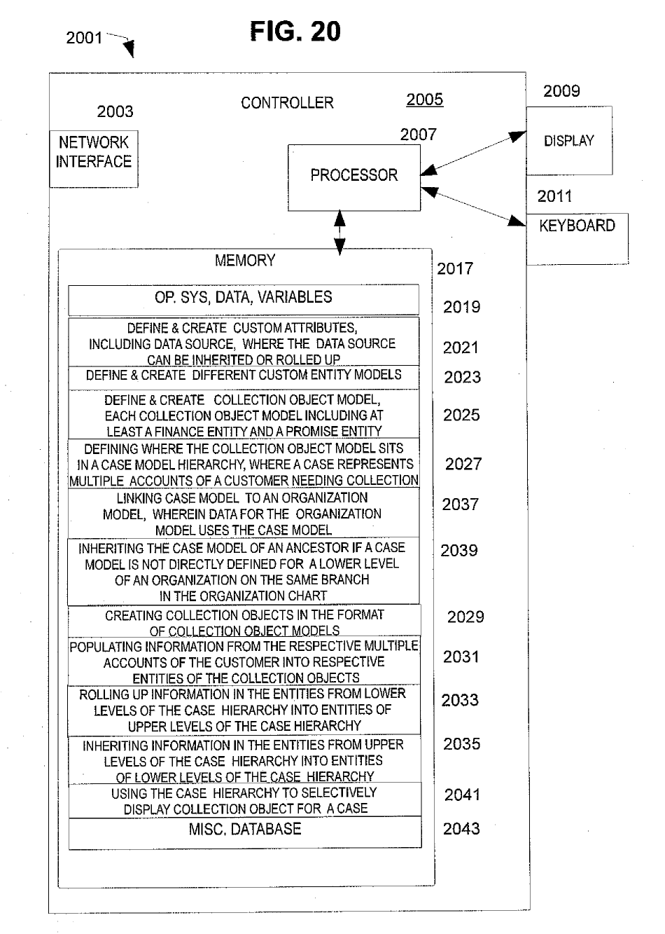

Referring now to FIG. 20, portions of an exemplary computer system for flexible case models will be discussed and described. The computer system 2001 may include a network interface 2003 and one or more controllers 2005. The network interface 2003 can be any conventional network interface, and may be wireless or wired. The controller 2005 may include a processor 2007, a memory 2017, and other optional components which will be well understood to those in this field. A display 2009 and a keyboard 2011 and/or other display and input device for interacting with the user can also be provided with the computer system 2001.

The processor 2007 may be, for example, one or more microprocessors and/or one or more digital signal processors. The memory 2017 may be coupled to the processor 2007 and may comprise a read-only memory (ROM), a random-access memory (RAM), a read/write flash memory, a programmable ROM (PROM), and/or an electrically erasable read-only memory (EEPROM). The memory 2017 may include multiple memory locations for storing, among other things, an operating system, data and variables 2019 for programs executed by the processor 2007; computer programs for causing the processor to operate in connection with various functions such as defining 2021 and creating custom attributes, defining 2023 and creating different custom entity models, defining 2025 and creating a collection object model, defining 2027 where the collection object models sit in a case model hierarchy, linking 2037 a case model to an organization model, inheriting 2039 the case model of an ancestor, creating 2029 collection objects, populating 2031 information from the respective accounts of the customer into respective entities of the collection objects, rolling up 2033 information in the entities, inheriting 2035 information in the entities, and using 2041 the case model hierarchy to selectively display a collection object for a case; and a database 2043 of various information used by the processor 2007. The computer programs may be stored, for example, in ROM or PROM and may direct the processor 2007 in controlling the operation of the computer system 2001. Each of these computer programs is discussed by way of example below.

The processor 2007 can be programmed for defining 2021 and creating custom attributes, so that the custom attribute includes a data source, where the data source can be defined as being inherited or rolled up. Specifically, if an attribute, defined as rolled-up, is to be at the account level or at any lower levels, the data value of the attribute is the actual data itself. However, if an attribute, defined as rolled-up, is at a level in the case model hierarchy which is higher than the account level or any lower levels, the data source can be defined as being rolled up from attributes at lower levels. A convenient example of rolling-up includes summing up amounts due which are in lower levels. If an attribute is to be at a level below the case level, the data source can for the attribute can be inherited from attributes which are at a higher level in the case model hierarchy. An example of this is inheriting a promise due date from a promise to pay several accounts, to promise due dates for lower levels. Fields where the data source is defined as being rolled up or inherited advantageously are contiguous in the case hierarchy. For example, field X at the account level is a data value. Field X in the case hierarchy directly above the account level can be defined with a data source of rolled up.

The processor 2007 can be programmed for defining 2023 and creating different custom entity models, where each custom entity model includes plural attributes. As discussed above, the different custom entity models can include at least a finance entity and a promise entity which a customer can promise to pay.

Also, the processor 2007 can be programmed for defining 2025 and creating a collection object model, where each collection object model includes at least a finance entity and a promise entity. The processor 2007 can be programmed for defining 2027 where the collection object models sit in a case model hierarchy, where a case represents multiple accounts of a customer needing collection.

The processor 2007 can be programmed for linking 2037 a case model to an organization model, wherein data for the organization model uses the case model. This is useful where, for example, different collections models are utilized within the same company, such as a utility company which might have a home cable organization (providing television, home telephone, internet, and cellular telephone) as well as a commercial organization (providing business telephone, business cellular telephones, and internet connectivity).

Also, the processor 2007 can be programmed for inheriting 2039 the case model of an ancestor in the case model hierarchy, where a case model is not directly defined for a lower level of an organization on the same branch in the a organization chart. Thus, a lower level of an organization can automatically inherit the case model of one of its ancestors. An organization chart is a tree which combines different case model hierarchies, where the different case model hierarchies represent a different branch of the organization. For example, collections for the business branch of a telecommunication company might have a case model hierarchy structure which is different from a non-commercial branch of the same company.

Furthermore, the processor 2007 can be programmed for creating 2029 collection objects in the format of collection object models. Once a case model hierarchy has been defined, the collection objects which are defined by the collection object models in the case model hierarchy can be populated for a particular case. The processor 2007 can be programmed for populating 2031 information from the respective multiple accounts of the customer into respective entities of the collection objects, as described above in more detail.

The processor 2007 can be programmed for rolling up 2033 information in the entities from lower levels of the case hierarchy into entities of the upper levels of the case hierarchy, as described above. Also, the processor 2007 can be programmed for inheriting 2035 information in the entities from upper levels of the case hierarchy into entities of lower levels of the case hierarchy, also as described above.

The processor 2007 can be programmed for using 2041 the case hierarchy to selectively display a collection object for a case. More particularly, the processor 2007 can operate in connection with the display 2009 to display the case hierarchy for a particular case. A collection object in the case hierarchy can be displayed only if there data to be displayed. For example, considering Table 1 above, if the case does not include credit cards, the collection objects for the Visa and MasterCard collection objects are not displayed, and the collection object for the credit cards is not displayed.

The data sources which are used by the flexible case model hierarchy can be stored locally, for example, in the misc. database 2043, and/or remote, as will be understood from FIG. 4.

It should be understood that various embodiments are described herein in connection with logical groupings of functions. One or more embodiments may omit one or more of these logical groupings. Likewise, in one or more embodiments, functions may be grouped differently, combined, or augmented.

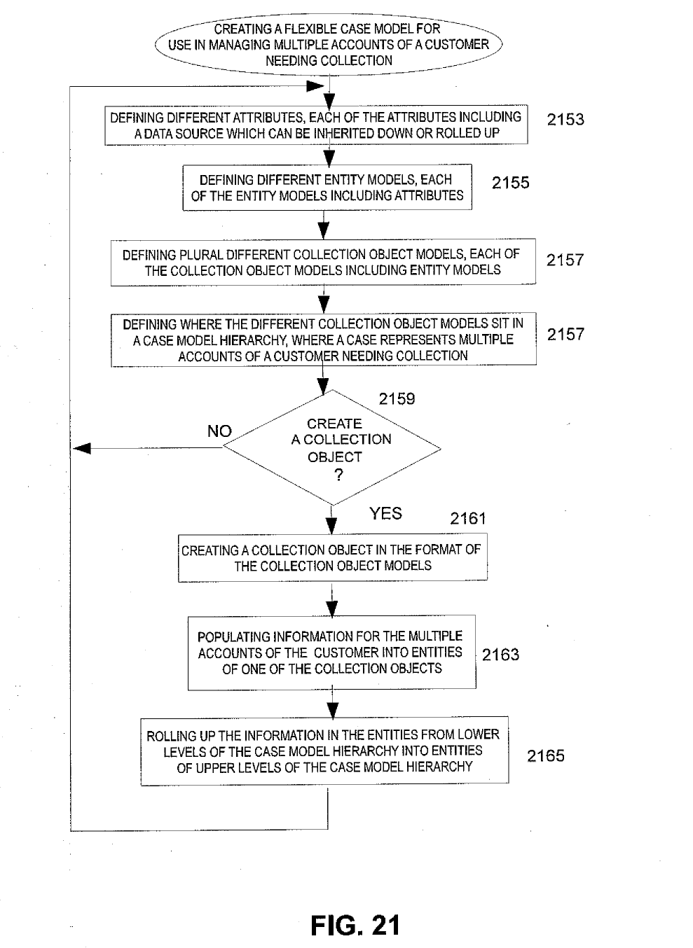

Referring now to FIG. 21, a flow chart illustrating an exemplary procedure for flexible case models will be discussed and described. The procedure can advantageously be implemented on, for example, a processor of a computer system, described in connection with FIG. 20 or other apparatus appropriately arranged.

A procedure for creating 2151a flexible case model for use in managing multiple accounts of a customer need collection can include first defining various object models. The procedure thus can include defining 2153 different attributes, each of the attributes including a data source which can be inherited down or rolled up. The procedure 2151 also can include defining 2155 different entity models, each of the entity models including one or more of the attributes which were defined. The procedure 2151 further can include defining 2157 plural different collection object models, each of the collection object models including one or more of the entity models which were defined.

Finally, the procedure 2151 can include defining 2157 where the different collection object models sit in a case model hierarchy, where a case represents multiple accounts of a customer needing collection.

Once a case model hierarchy has been defined to include collection object models, collection objects (or cases) can be created. Thus, if 2159 a collection object is to be created, the procedure 2151 can include creating 2161a collection object in the format of the collection object models, by applying the collection object model to an actual case. The procedure 2151 includes populating 2163 information for the multiple accounts of the customer into entities of one or more of the respective collection objects within that customer's case. Optionally, the procedure 2151 can include rolling up 2165 information in the entities from lower levels of the case model hierarchy into entities of upper levels of the case model hierarch, and/or inheriting information from high level entities to lower level entities, as defined in the collection object models. A case with the collection objects which were created can be displayed, as discussed in detail above.

These processes have been described in detail above, and hence have not been repeated in detail here.

Various flow charts are used herein to describe the operation. These flow charts illustrate examples, and it should be understood that these flow charts can easily be modified to illustrated changes which are encompassed by the embodiments. For example, in the flow charts, operations can be performed in a different order, and many of the operations can be eliminated or added to various embodiments. Such changes should be considered to be within the spirit and scope.

The many features and advantages of the invention are apparent from the detailed specification and, thus, it is intended by the appended claims to cover all such features and advantages of the invention which fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A computer-implemented method of creating a flexible case model for use in managing collections of multiple accounts of a customer needing collection, comprising:
defining attributes, each of the attributes including a data source, wherein the data source can be inherited or rolled up;
defining plural different entity models, wherein each of the entity models includes a plurality of the attributes, the different entity models being (i) a finance entity, and (ii) a promise entity which a customer can promise to pay; and
defining plural collection object models, wherein each of the collection object models includes a plurality of the entity models, including a finance entity and a promise entity; and
defining where the plural collection object models sit in a case model hierarchy, wherein a case represents multiple accounts of a customer needing collection.

2. The method of claim 1, further comprising:
creating collection objects in the format of the plural collection object models;
populating information for the respective multiple accounts of the customer into entities of one of the collection objects; and
rolling up the information in the entities from lower levels of the case model hierarchy into entities of upper levels of the case model hierarchy.

3. The method of claim 1, wherein defining the collection object models further can include selectively defining the collection object models to include a skip trace contact entity, a history entity, and a collateral entity.

4. The method of claim 1, wherein the entity can be:
a single attribute, or
a list of attributes, further comprising calling the attributes can be individually from the list.

5. The method of claim 1,
further comprising linking plural case models in the format of the case model hierarchy to an organization model,
wherein data for the organization uses the plural case models.

6. The method of claim 5, further comprising a lower level of the organization chart inheriting one of the case models of an ancestor in the organization if a case model is not directly defined for the lower level.

7. The method of claim 1, further comprising customizing the entity models, the collection object models, and the case model hierarchy.

8. The method of claim 1, wherein the attributes in the promise entity include a customer promise payment amount and a customer promise payment date.

9. The method of claim 1, wherein the attributes further include an attribute description, a data type and a format.

10. A computer-implemented method of using a flexible case model in managing collections, comprising:
using a case model hierarchy to display a case, wherein an attribute can be displayed as inherited or rolled up and contact entities for the case object and its child case objects are displayed as a view, grouped together at a parent level view,
wherein a case includes information for respective multiple accounts of a customer needing collection.

11. The method of claim 10, wherein the case model hierarchy includes:
plural attributes, each of the attributes including a data source, wherein the data source is displayed as inherited or rolled up;
plural different entity models, wherein each of the entity models includes a plurality of attributes, the different entity models being (i) a finance entity, and (ii) a promise entity which a customer can promise to pay;
plural collection object models, wherein each of the collection object models includes a plurality of entity models, including a finance entity and a promise entity; and
a definition of where the plural collection object models sit in the case model hierarchy.

12. The method of claim 11, further comprising:
creating collection objects in the format of the plural collection object models;
populating information for respective multiple accounts of a customer needing collection into entities of one of the collection objects; and
rolling up the information in the entities from lower levels of the case model hierarchy into entities of upper levels of the case model hierarchy.

13. The method of claim 10,
wherein a collection object can be shared by plural different cases.

14. The method of claim 10, wherein only actual instances in the case model are displayed.

15. A computer-implemented data management system for using a flexible case model for managing collections of multiple accounts of a customer needing collection comprising:
a case model creator configured to
define and create attributes, each of the attributes including a data source and attribute description, wherein the data source can be inherited or rolled up;
define and create plural different entity models, wherein each of the entity models includes a plurality of attributes, the different entity models being (i) a finance entity, and (ii) a promise entity which a customer can promise to pay; and
define and create plural collection object models, wherein each of the collection object models includes a plurality of entity models, including a finance entity and a promise entity;
define where the plural collection object models sit in a case model hierarchy; and
a display component that can selectively display the collection object for a case to a user in order and with roll-ups and inheritance of the case model hierarchy,
wherein a case represents multiple accounts of a customer needing collection.

16. The system of claim 15, wherein the case model creator is further configured for:
creating collection objects in the format of the plural collection object models;
populating information for respective multiple accounts of a customer needing collection into entities of one of the collection objects; and
rolling up the information in the entities from lower levels of the case model hierarchy into entities of upper levels of the case model hierarchy.

17. The system of claim 15, wherein the collection object models further can include a skip trace contact entity, a history entity, and a collateral entity.

18. The system of claim 15, wherein the entity can be:
a single attribute, or
a list of attributes wherein the attributes can be individually called out from the list.

19. The system of claim 15,
wherein plural case models in the format of the case model hierarchy are linked to an organization model,
wherein data for the organization uses the plural case models.

20. The system of claim 19, wherein a lower level of the organization chart inherits one of the case models of an ancestor in the organization if a case model is not directly defined for the lower level.

21. The system of claim 15, wherein the case model creator is further configured for customizing the entity models, the collection object models, and the case model hierarchy.

22. The system of claim 15, wherein the attributes in the promise entity include a customer promise payment amount and a customer promise payment date.
